(19) United States
(12) Patent Application Publication
(10) Pub. No.: US 2010/0141997 A1
(43) Pub. Date: Jun. 10, 2010

(54) CONTENT VIEWING APPARATUS AND COMPUTER-READABLE RECORDING MEDIUM STORING CONTENT VIEWING PROGRAM

(75) Inventor: Hiroaki SUZUKI, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 12/711,441

(22) Filed: Feb. 24, 2010

Related U.S. Application Data
(63) Continuation-in-part of application No. PCT/JP2008/065386, filed on Aug. 28, 2008.

(30) Foreign Application Priority Data
Sep. 17, 2007 (JP) 2007-240316

(51) Int. Cl. G06F 15/00

(52) U.S. Cl. 358/1.15

(57) ABSTRACT

A content viewing apparatus capable of performing the transfer and copying of a content, includes a display device that displays the content composed of an image or a document, an information acquiring device that acquires route information composed of identification information including at least one of device identification information which identifies a stopover device over which the content has stopped and user identification information which identifies a user of the stopover device, and content information which relates to the substance itself of the content, a route information creating device that creates route information obtained by adding identification information of the content viewing apparatus itself as a stopover device to the route information acquired by the information acquiring device, and a route information storing device that associates the route information created by the route information creating device with the content information and store the associated information into a storing device.

### CROSS-REFERENCE TO RELATED APPLICATION

This application is a continuation-in-part of International Application No. PCT/JP2008/065386, filed Aug. 28, 2008, which claims priority from Japanese Patent Application No. 2007-240316, filed on Sep. 17, 2007. The disclosure of the foregoing application is hereby incorporated by reference in its entirety.

### BACKGROUND

This disclosure relates to a content viewing apparatus which can recognize devices over which a content has stopped and a computer-readable recording medium on which a content viewing program is recorded.

A conventional content viewing apparatus to view and distribute a content composed of an image or a document has been known. When a content is to be viewed and distributed by using such a content viewing apparatus, the content may be copied, transferred, and lost in the middle of viewing and distribution, causing a risk of a content leakage.

For this reason, proposed is a content managing method for adding to a copied content copying device-related information serving as information of a device which produces a copy of a content.

### SUMMARY

However, in the conventional content managing method, information of a device which has produced a copy of a content is printed only at the time of printing the content, and devices over which the content has stopped cannot be recognized. Therefore, even though an information leakage can be detected, the user of a device who leaked information cannot be specified.

This disclosure has been made to solve the above problem, and an object of the disclosure is to provide a content viewing apparatus which can recognize devices over which a content has stopped, and a computer-readable recording medium on which a content viewing program is recorded.

To solve the problem described above, in a first aspect of this disclosure, a content viewing apparatus capable of performing the transfer and copying of a content includes a display device that displays the content composed of an image or a document, an information acquiring device that acquires route information composed of identification information including at least one of device identification information which identifies a stopover device over which the content has stopped and user identification information which identifies a user of the stopover device, and content information which relates to the substance itself of the content, a route information creating device that creates route information obtained by adding identification information of the content viewing apparatus itself as a stopover device to the route information acquired by the information acquiring device, and a route information storing device that associates the route information created by the route information creating device with the content information and store the associated information into a storing device.

To solve the problem described above, in a second aspect of this disclosure, a computer-readable recording medium storing a content viewing program of a content viewing apparatus capable of performing the transfer and copying of a content composed of an image or a document is recorded, wherein the program includes an information acquiring step of acquiring route information composed of identification information including at least one of device identification information which identifies a stopover device over which the content has stopped and user identification information which identifies a user of the stopover device, and content information which relates to the substance itself of the content, a route information creating step of creating route information obtained by adding identification information of the content viewing apparatus itself as the stopover device to the route information acquired in the information acquiring step, and a route information storing step of storing the route information created in the route information creating step in association with the content information.

Other objects, features, and advantages of the present disclosure will be apparent to persons of ordinary skill in the art in view of the following detailed description of embodiments of the invention and the accompanying drawings.

### BRIEF DESCRIPTION OF THE DRAWINGS

Exemplary embodiments of the invention will be described below in detail with reference to the accompanying drawings in which:

FIG. 1 is a system configuration diagram showing an outline of a content viewing system according to an embodiment of the invention;

FIG. 2 is a block diagram showing an electrical configuration of a mobile apparatus;

FIG. 3 is a pattern diagram showing a configuration of content data stored in a content data storage area of a memory card;

FIG. 4 is a pattern diagram showing a configuration of an EEPROM;

FIG. 5 is a block diagram showing an electrical configuration of a computer apparatus;

FIG. 6 is a flow chart of a mobile apparatus main process performed by a mobile apparatus according to a first embodiment;

FIG. 7 is a flow chart showing a route check process executed in the mobile apparatus main process;

FIG. 8 is a flow chart showing a list display process executed in the mobile apparatus main process;

FIG. 9 is a flow chart of a key input waiting process executed in the mobile apparatus main process;

FIG. 10 is a flow chart of a content selecting process executed in the key input waiting process;

FIG. 11 is a flow chart of a content determining process executed in the key input waiting process;

FIG. 12 is a flow chart of a page turning process executed in the key input waiting process;

FIG. 13 is a flow chart of a content transmitting process executed in the key input waiting process;

FIG. 14 is a flow chart of a route display process executed in the key input waiting process;

FIG. 15 is a flow chart of a route addition process executed in the mobile apparatus main process;

FIG. 16 is a flow chart of a content printing process executed in the key input waiting process;

FIG. 17 is a flow chart of a route list generating process executed in the content printing process;

FIG. 18 is a diagram showing a printed matter on which the content data shown in FIG. 3 is printed;

FIG. 19 is a flow chart of a content receiving process executed by a computer apparatus;

FIG. 20 is a flow chart of a route addition process executed in the content receiving process;

FIG. 21 is a flow chart of a content transmitting process executed by the computer apparatus;

FIG. 22 is a flow chart of a first modification of the route list generating process shown in FIG. 17;

FIG. 23 is a pattern diagram showing a configuration of content data obtained when a level of a user is stored together with identification information;

FIG. 24 is a flow chart of a second modification of the route list generating process shown in FIG. 17;

FIG. 25 is a flow chart of a content transmitting process executed by a mobile apparatus according to a second embodiment;

FIG. 26 is a flow chart of a content transmitting process executed by a mobile apparatus according to a third embodiment;

FIG. 27 is a flow chart of a deletion route selecting process executed in the content transmitting process in the third embodiment;

FIG. 28 is a flow chart of a first modification of the deletion route selecting process shown in FIG. 27;

FIG. 29 is a flow chart of a second modification of the deletion route selecting process shown in FIG. 27;

FIG. 30 is a flow chart of a content printing process executed by a mobile apparatus according to a fourth embodiment;

FIG. 31 is a flow chart of a route addition process executed by a mobile apparatus according to a fifth embodiment; and

FIG. 32 is a flow chart of a content transmitting process executed by a mobile apparatus according to a sixth embodiment.

### DETAILED DESCRIPTION OF EMBODIMENTS

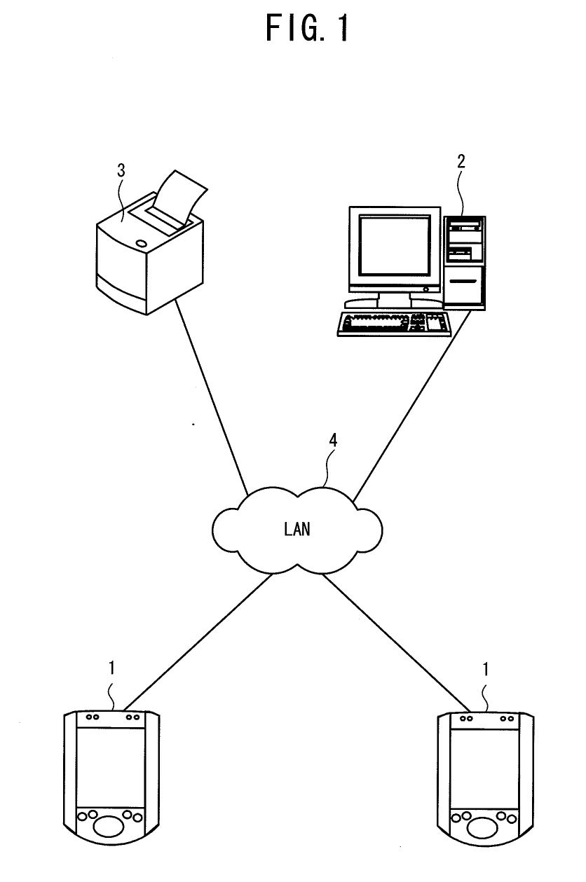

An embodiments of this disclosure will be described below with reference to the accompanying drawings. With reference to FIG. 1, a description will be given of an outline of a content viewing system 100 according to the embodiment. As shown in FIG. 1, the content viewing system 100 is configured by a plurality of mobile apparatuses 1, a computer apparatus 2, and a printing apparatus 3. These apparatuses are connected to one another via a LAN 4.

The mobile apparatus 1 is a mobile-type apparatus having a display portion, and can perform transmission and reception of information with another mobile apparatus 1 and the computer apparatus 2 or transmission of a printing instruction to the printing apparatus 3. The mobile apparatus 1 downloads content data (which will be described later) from another device and displays a content composed of characters or an image on the display portion. The mobile apparatuses 1 can also transfer content data among the mobile apparatuses by exchanging a memory card in which the content data is stored. The content data is composed of content information, a content name, and attached information such as route information related to a content. The content information is information including characters, an image, a video, or a combination thereof. The content data will be described later.

The computer apparatus 2 includes a hard disk drive (HDD) and a display portion 25 and can create a content. The computer apparatus 2 displays a created content or a content downloaded from another device on the display portion 25. The computer apparatus 2 can convert the created content into data which can be viewed by the mobile apparatus 1, and store the data in the HDD or memory card. Therefore, by turning over the memory card to another device, the computer apparatus 2 can transfer the content data without the LAN 4. Furthermore, the computer apparatus 2 can also transmit the content data stored in the HDD to another device through the LAN 4, and can transmit a printing instruction to the printing apparatus 3 to print a content.

As the printing apparatus 3, a printing apparatus which can receive print data from the mobile apparatus 1 or the computer apparatus 2 to execute a print operation may be used. Any printing scheme such as a laser scheme or an ink-jet scheme may be employed. In this embodiment, the mobile apparatus 1 or the computer apparatus 2 creates print data to transmit the print data to the printing apparatus 3. However, the mobile apparatus 1 or the computer apparatus 2 may transmit content data itself to the printing apparatus 3, and the printing apparatus 3 may expand print data on the basis of the data transmitted. A connection between the devices via the LAN 4 may be a wired connection or a wireless connection. The devices need not always be connected, and merely have to be connected to each other only when data or a printing instruction is transmitted or received. The devices may also be directly connected to each other by a USB or the like without using the LAN 4.

In the embodiment (described below), route information is stored together with content information. The route information is updated each time a content is transferred and copied. The route information is information of a content transfer route between the devices. The details of the route information will be described later. When the content is to be printed, the route information is printed together with the content. Accordingly, the user can recognize devices over which the content has stopped.

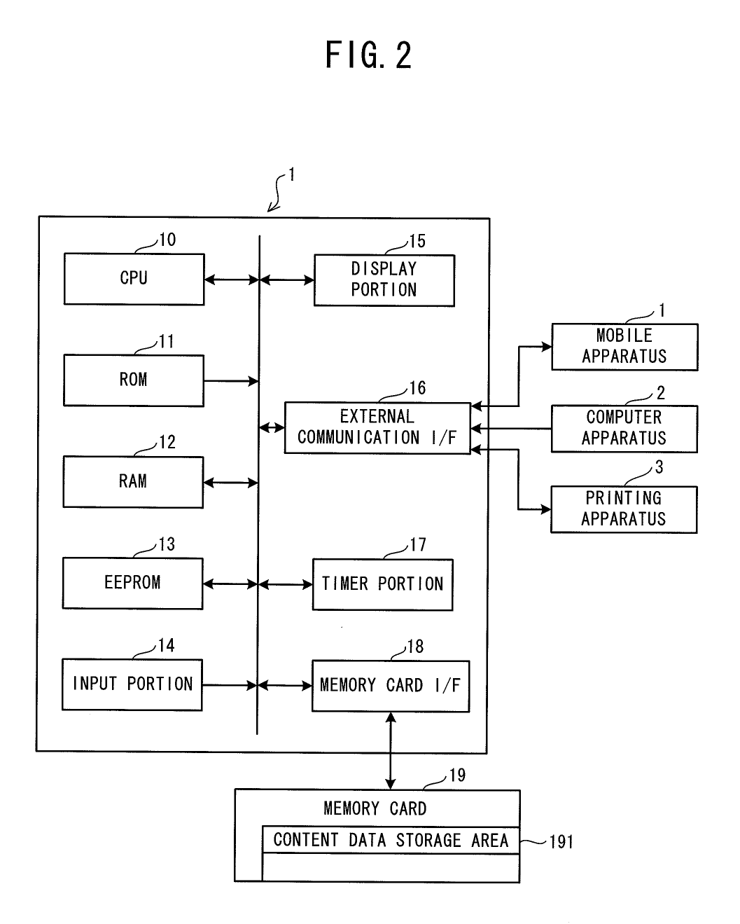

An electrical configuration of the mobile apparatus 1 will be described below with reference to FIGS. 2 to 4.

As shown in FIG. 2, the mobile apparatus 1 is provided with a CPU 10 which controls the mobile apparatus 1. The CPU 10 is connected to a ROM 11, a RAM 12, an EEPROM 13, an input portion 14, a display portion 15, an external communication I/F 16, a timer portion 17, and a memory card I/F 18 via a bus. The ROM 11 stores a program or the like to operate the mobile apparatus 1, the RAM 12 temporarily stores various data, and the EEPROM 13 is a non-volatile memory. The input portion 14 includes a button or an arrow key and accepts an input made by a user. The display portion 15 displays a content. The external communication I/F 16 connects the mobile apparatus 1 to another device such as the computer apparatus 2, the printing apparatus 3, or another mobile apparatus 1. The timer portion 17 measures time. The memory card I/F 18 connects a memory card 19 to the mobile apparatus 1. The memory card 19 includes a content data storage area 191 which stores content data.

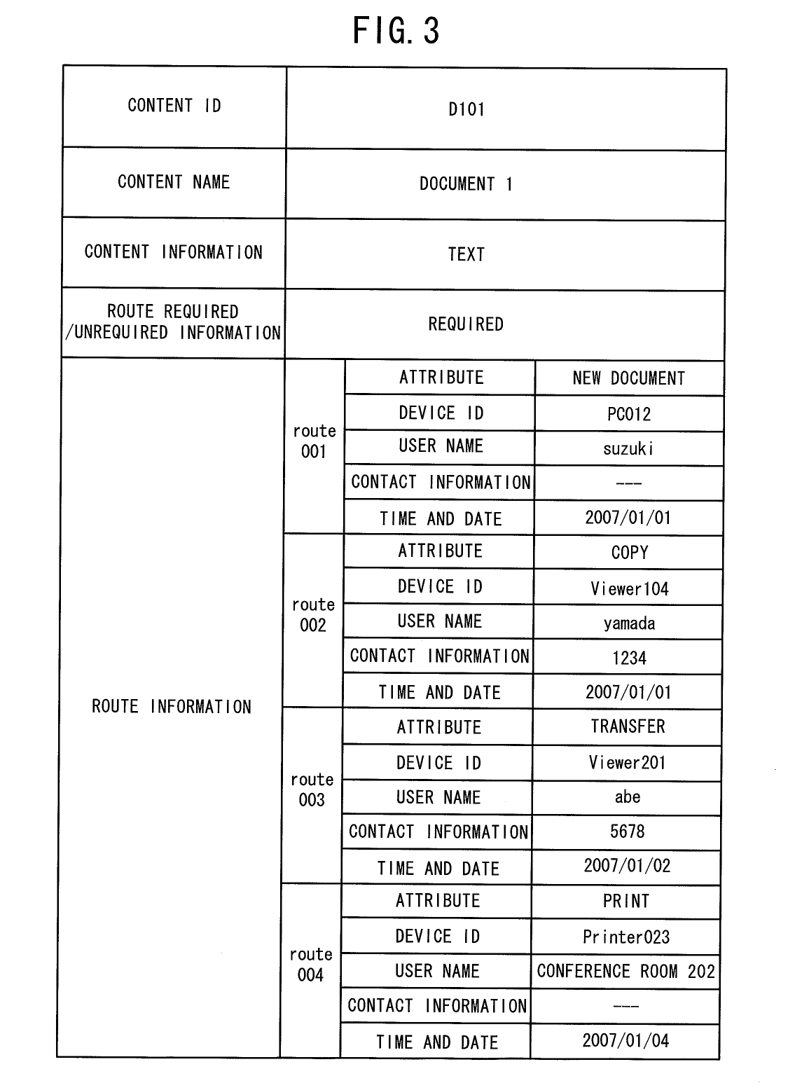

With reference to FIG. 3, a description will be given of a configuration of content data to be stored in the content data storage area 191 of the memory card 19. As shown in FIG. 3, the content data is composed of a content ID, a content name, content information, route required/unrequired information, and route information. The content ID is an ID unique to each content. The route required/unrequired information indicates whether to store a route of a content. The route information indicates devices over which a content has stopped. The content data is stored for each content. The route information is created and stored when the route required/unrequired information indicates that the route of the content should be stored. The route information is composed of an attribute, contact information, a time and date, and identification information. The attribute indicates any one of “new document”, “transfer”, “copy”, and “print”. The contact information indicates contact information for a user. The time and date indicate the time and date at which a device over which a content has stopped acquires a content. The identification information is composed of a device ID and a user name and is related to devices over which the content has stopped (to be referred to as stopover devices hereinafter). The device ID indicates a device ID of the stopover device and is device identification information to identify the stopover device. The user name indicates a user name of a stopover device and is user identification information to identify a user of the stopover device. In this case, information such as a device ID constituting the route information is changeable. For example, the contact information need not always be stored, and other information may be newly stored as route information.

In the example shown in FIG. 3, content data having “D101” as the content ID is described. This content is composed of a document, and its content name is “document 1”. The route information is created and stored since the route required/unrequired information indicating whether to store the route of the content is “required”. “PC012” which is the device ID of a first stopover device and “suzuki” which is the user name of the first stopover device are stored in a “route001” field as identification information about the first stopover device. In the “route001” field, “new document” indicating that a content was newly created by the first stopover device is stored as an attribute. “2007/01/01” which is the time and date at which the content was newly created is stored. Since contact information of a user was not registered in the device having “PC012” as the device ID, the contact information is not stored.

In the “route002” field, “Viewer 104” which is the device ID of a second stopover device and “yamada” which is a user name of the second stopover device are stored as identification information. As the attribute, “copy” is stored which indicates that a content was copied from the first stopover device to the second stopover device. “1234” which is the extended number of contact information of “yamada” and “2007/01/01” which is the time and date at which the content was copied to the second stopover device are stored in the “route002” field of the route information. Similarly, information related to a third stopover device is stored in the “route003” field, and information related to a fourth stopover device is stored in a “route004”. Details of an operation related to creation and storage of the route information will be described below with reference to the drawings.

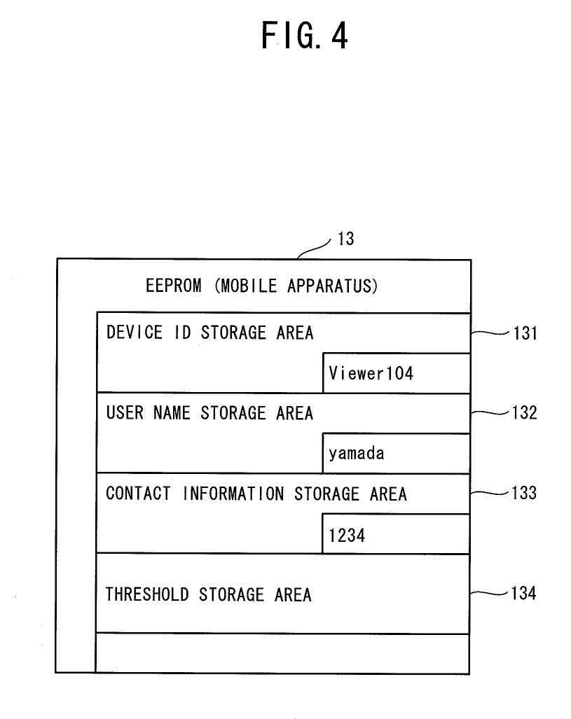

A configuration of the EEPROM 13 will be described below with reference to FIG. 4. The EEPROM 13 of the mobile apparatus 1 is provided with at least a device ID storage area 131, a user name storage area 132, a contact information storage area 133, and a threshold storage area 134. In the device ID storage area 131, a device ID to identify the mobile apparatus from other devices is stored. In the user name storage area 132, a name of a user who uses the mobile apparatus 1 is stored. In the contact information storage area 133, contact information of the user who uses the mobile apparatus 1 is stored. In the threshold storage area 134, various thresholds such as a maximum number of pieces of printable identification information are stored. The mobile apparatus 1 of the example shown in FIG. 4 has “Viewer 104” as a device ID, “yamada” as a user name, and “1234” as an extended number of the contact information of the user. In the embodiment, the device ID is stored in the EEPROM 13 in advance in the manufacture of the mobile apparatus 1, and a user name and contact information are registered and changed by a user. The pieces of information stored in the EEPROM 13 are stored into the content data storage area 191 of the memory card 19 as route information (see FIG. 3). The thresholds stored in the threshold storage area 134 can be changed.

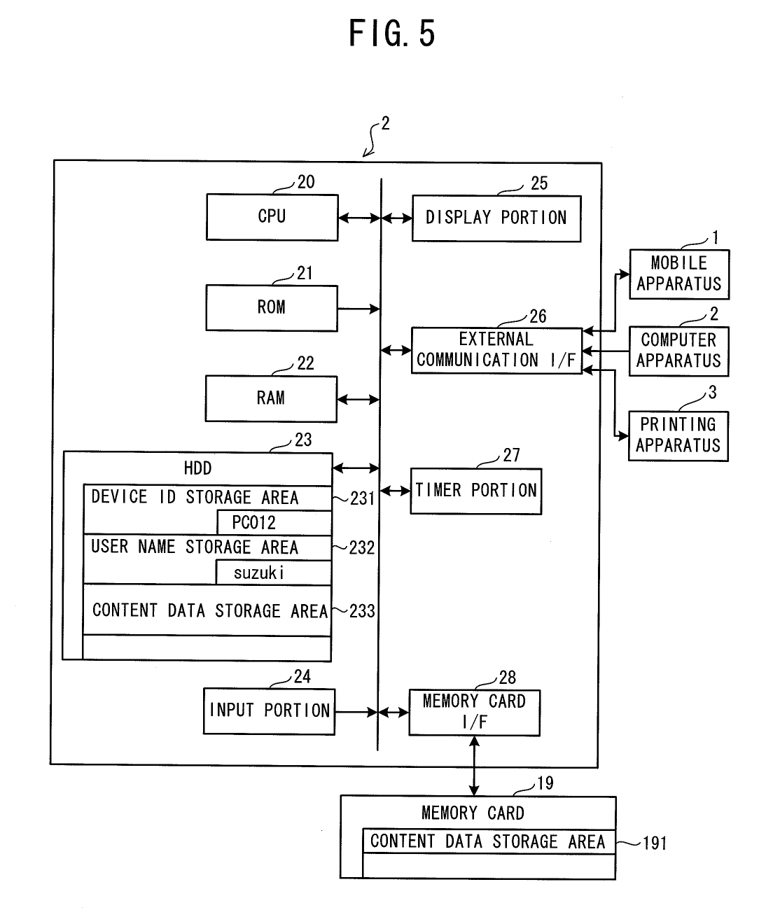

An electrical configuration of the computer apparatus 2 will be described below with reference to FIG. 5. As shown in FIG. 5, the computer apparatus 2 includes a CPU 20 which controls the computer apparatus 2. The CPU 20 is connected to a ROM 21, a RAM 22, a hard disk drive (HDD) 23, an input portion 24, a display portion 25, an external communication I/F 26, a timer portion 27, and a memory card I/F 28 via a bus. The ROM 21 stores a program or the like to operate the computer apparatus 2. The RAM 22 temporarily stores various data. The HDD 23 stores various pieces of information. The input portion 24 is constituted by a keyboard and a mouse, and accepts an input made by a user. The display portion 25 is constituted by a display for outputting an image. The external communication I/F 26 connects the computer apparatus 2 to another device. The timer portion 27 measures time. The memory card I/F 28 connects the memory card 19 to the computer apparatus 2.

The HDD 23 includes at least a device ID storage area 231, a user name storage area 232, and a content data storage area 233. The device ID storage area 231 stores a device ID to identify the computer apparatus 2 from other devices. The user name storage area 232 stores the name of a user who uses the computer apparatus 2. The content data storage area 233 stores content data. The computer apparatus 2 in the example shown in FIG. 5 has “PC012” as a device ID stored in advance in the manufacture of the computer apparatus 2 and “suzuki” as a registered user name. In the computer apparatus 2, an entire content data including the substance of the content is created. The content data is converted into data which can be viewed by the mobile apparatus 1. The converted data is stored into the content data storage area 191 of the memory card 19 and the content data storage area 233 of the HDD 23.

The printing apparatus 3 will be described below. The printing apparatus 3 includes an EEPROM serving as a non-volatile memory like the mobile apparatus 1. The EEPROM is provided with a device ID storage area and a user name storage area. The device ID storage area stores a device ID to discriminate the printing apparatus 3 from other devices. The user name storage area stores the name of a user or a group who uses the printing apparatus 3 and information such as an installation place. In the embodiment, a request to transmit identification information is transmitted from the mobile apparatus 1 and the computer apparatus 2 to the printing apparatus 3 before printing. The printing apparatus 3 having received the transmission request transmits the device ID and the user name which are identification information of the printing apparatus 3 itself. In this manner, route information including information of copy by printing is created. Details of creation of the route information will be described later with reference to the flow chart.

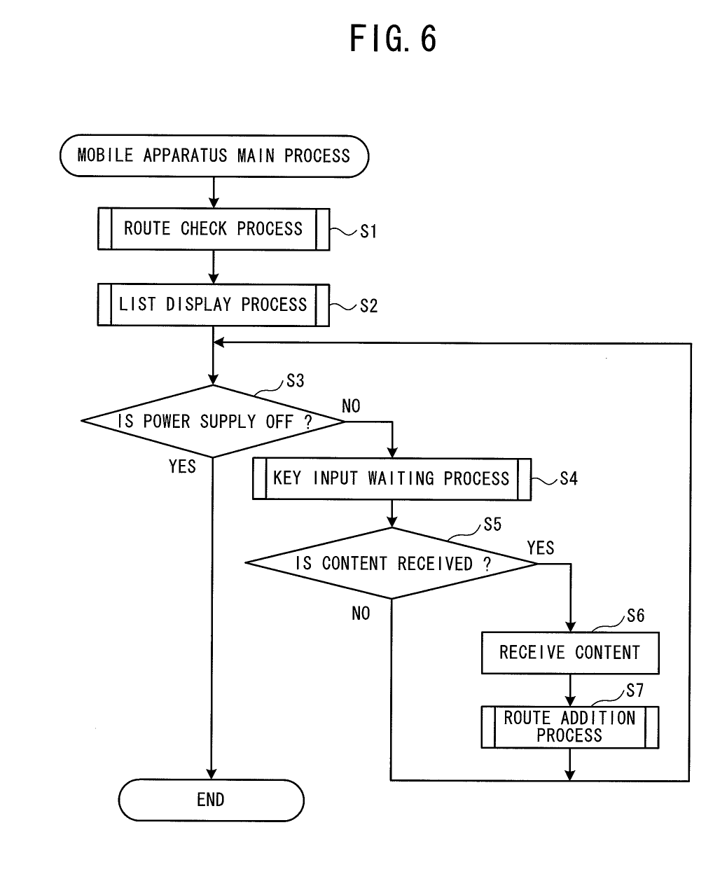

An operation of the mobile apparatus 1 according to the first embodiment configured as described above will be described below with reference to FIGS. 6 to 18.

In the mobile apparatus 1, when a power supply is turned on, the program stored in the ROM 11 is lead into the RAM 12 and started, and the mobile apparatus main process shown in FIG. 6 is executed by the CPU 10. A route check process is first executed (S1). This route check process is performed so as to always create and store the latest route information even though the memory cards 19 are exchanged while the power supply of the mobile apparatus 1 is in an “OFF” state.

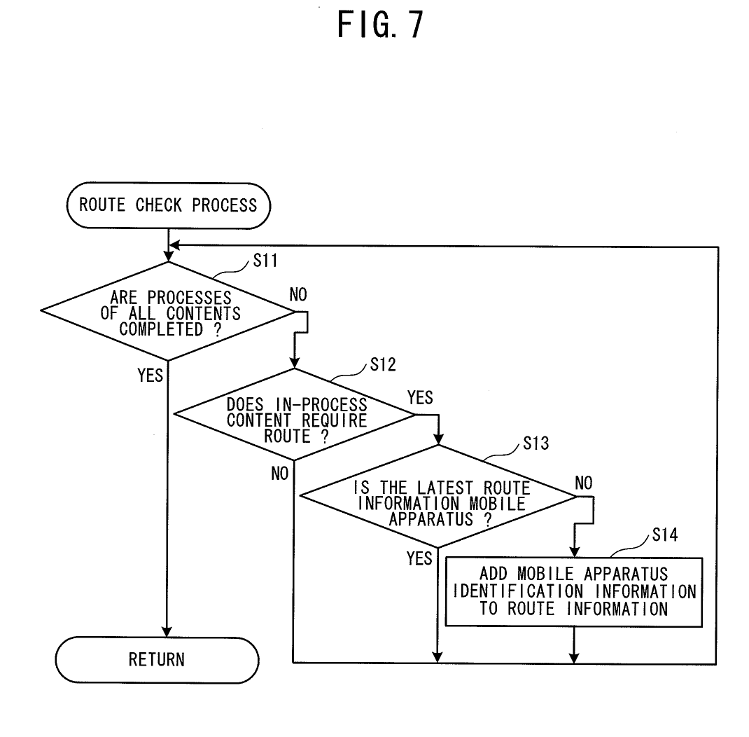

Details of the route check process will be described below with reference to FIG. 7. As shown in FIG. 7, in the route check process, it is determined whether check process for all content data stored in the memory card 19 are completed (S11). When the process are not completed yet (S11: NO), check process for the route of the content data is sequentially performed (S12 to S14). First, it is determined whether a route of the in-process content data should be stored (S12). When the route required/unrequired information of the content data (see FIG. 3) does not indicate that the route of the content should be stored (S12: NO), the process directly returns to the determination in step S11. When the route required/unrequired information indicates that the route should be stored (S12: YES), it is determined whether the latest identification information in the route information of the content data is identification information of the mobile apparatus 1 itself (S13). The latest identification information indicates a device ID and a user name stored in a field having the largest “route” number among pieces of the route information shown in FIG. 3. When the device ID of the latest identification information is matched with the device ID of the mobile apparatus 1 itself (S13: YES), it is indicated that transfer, copying, or the like from the mobile apparatus 1 to another device is performed without passing through the memory card 19. For this reason, the process directly returns to the determination in S11. On the other hand, when the device ID of the latest identification information is not matched with the device ID of the mobile apparatus 1 itself and it is determined that the latest identification information is not information of the mobile apparatus 1 itself (S13: NO), the device ID, the user name, and the contact information stored in the EEPROM 13 (see FIG. 4), a current time measured by the timer portion 17, and “transfer” which indicates an attribute are added to the route information (S14). The process then returns to the determination in S11. When the check process for all the content data are completed (S11: YES), the process returns to a mobile apparatus main process.

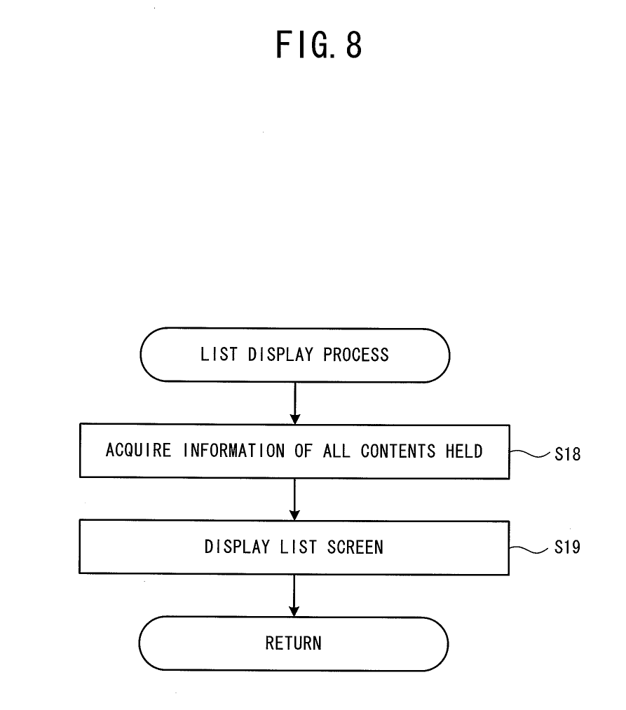

As shown in FIG. 6, when the route check process (S1) are finished, a list display process is executed (S2). In the list display process, as shown in FIG. 8, pieces of information (content ID, content name, or the like) of all the contents stored in the memory card 19 are acquired (S18), and a list screen of the all contents is displayed on the display portion 15 (S19). The process then returns to the mobile apparatus main process.

When a power-off operation is executed (S3: YES) upon completion of the list display process (S2), the mobile apparatus main process is finished. When the power-off operation is not executed (S3: NO), the processes in S4 to S7 are repeated. First, a key input waiting process is executed (S4). The key input waiting process is a process of calling various functions of the mobile apparatus 1 in accordance with an input operation from the input portion 14. In this case, seven processes including a content selection process, a content determination process, a page turning process, a list display process, a content printing process, a content transmitting process, and a route display process are given. However, operations which can be performed by the mobile apparatus 1 are not limited to the seven processes.

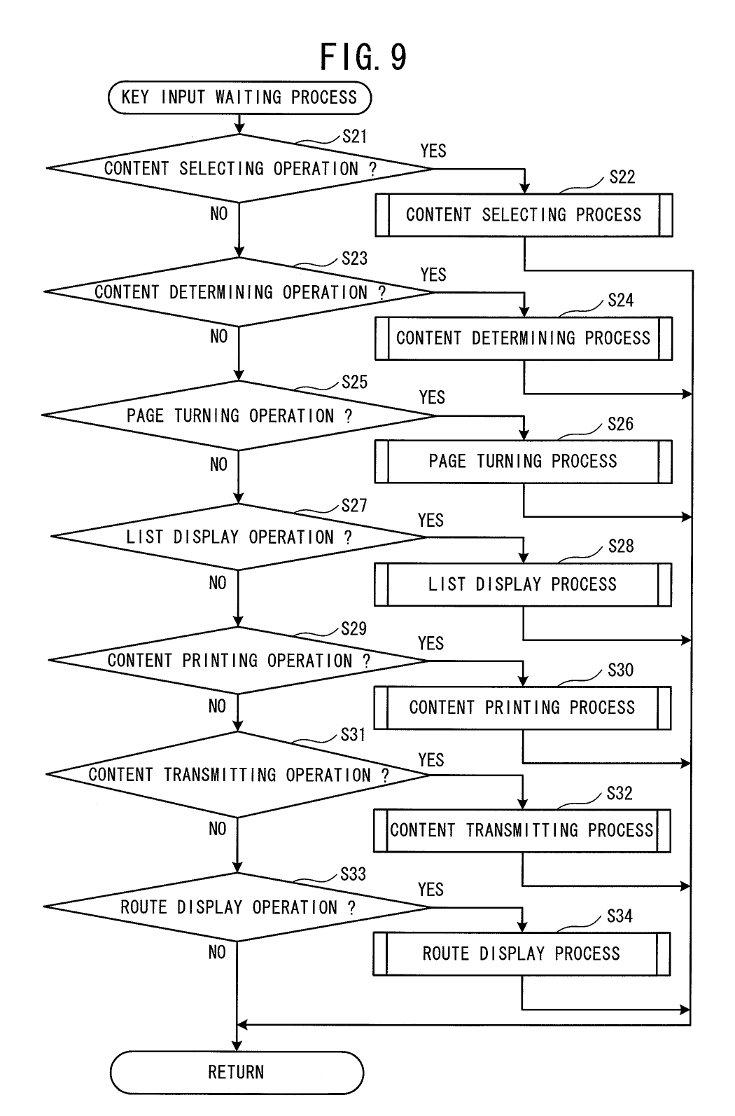

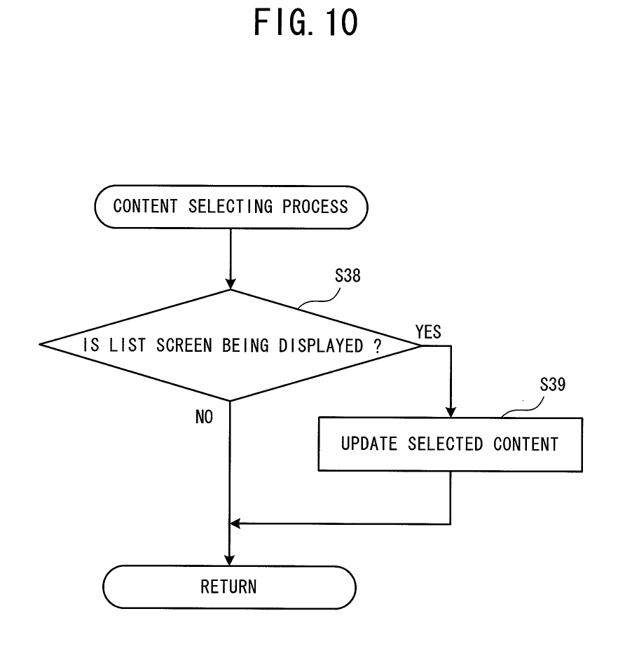

As shown in FIG. 9, when a key input waiting process is started, it is determined whether a content selecting operation has been performed by an up/down button of the input portion 14 (S21). When the content selecting operation is performed (S21: YES), a content selecting process is executed (S22). In the content selecting process, as shown in FIG. 10, when a list screen is being displayed on the display portion 15 (S38: YES), a selected content which is highlighted among the contents in the list screen is updated (S39). The process returns to the key input waiting process and then returns to the mobile apparatus main process. When the list screen is not displayed (S38: NO), the key operation becomes invalid, the process directly returns to the key input waiting process and then directly returns to the mobile apparatus main process.

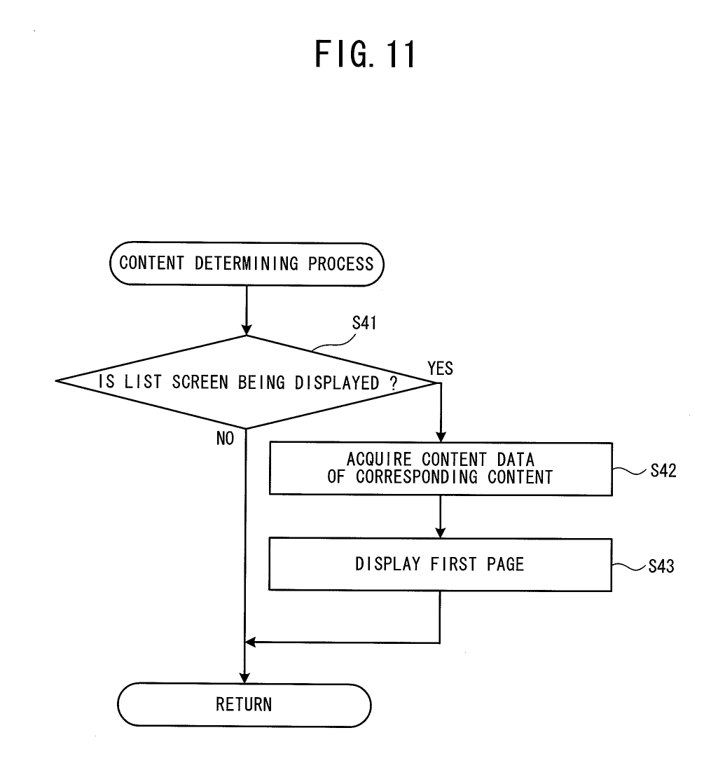

When the content selecting operation is not performed (S21: NO), it is determined whether a content determining operation has been performed by a determination button (S23). When the content determining operation is performed (S23: YES), a content determining process is executed (S24). In the content determining process, as shown in FIG. 11, when a display screen is being displayed on the display portion 15 (S41: YES), content data of a selected content which is highlighted among the contents in the list screen is acquired from the memory card 19 (S42). The first page of the substance of the content is displayed on the display portion 15 (S43). The process returns to the key input waiting process and then returns to the mobile apparatus main process. When the list screen is not displayed (S41: NO), this key operation becomes invalid, and the process directly returns to the key input waiting process and then directly returns to the mobile apparatus main process.

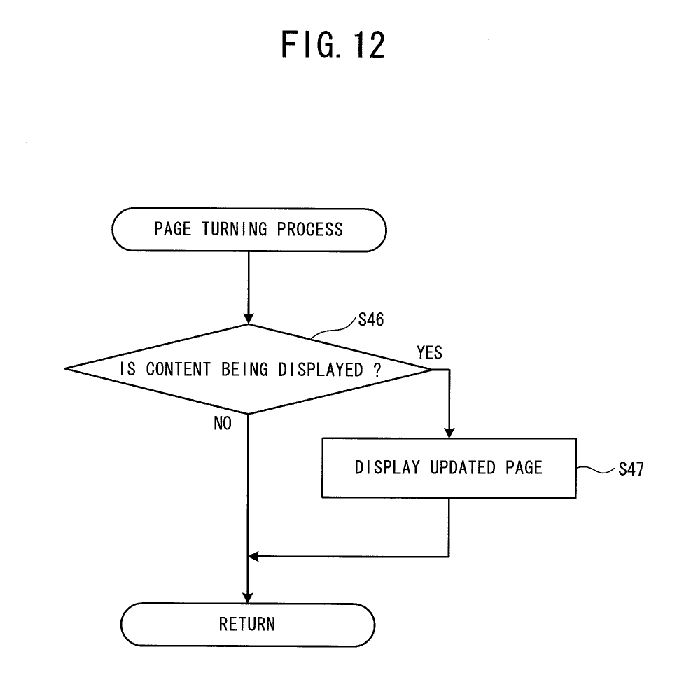

When the content determining operation is not performed (S23: NO), it is determined whether a page turning operation has been performed by a right/left button of the input portion 14 (S25). When the page turning operation is performed (S25: YES), a page turning process is executed (S26). In the page turning process, as shown in FIG. 12, when a content is being displayed on the display portion 15 (S46: YES), an updated page (next page or previous page) of the currently displayed content is displayed (S47). The process returns to the key input waiting process and then returns to the mobile apparatus main process. When the content is not displayed (S46: NO), this key operation becomes invalid, and the process directly returns to the key input waiting process and then directly returns to the main process.

When the page turning operation is not performed (S25: NO), it is determined whether the list display operation key has been operated (S27). When the list display operation key is operated (S27: YES), a list display process (see FIG. 8) like the above described process in S2 is executed (S28). The process returns to the mobile apparatus main process.

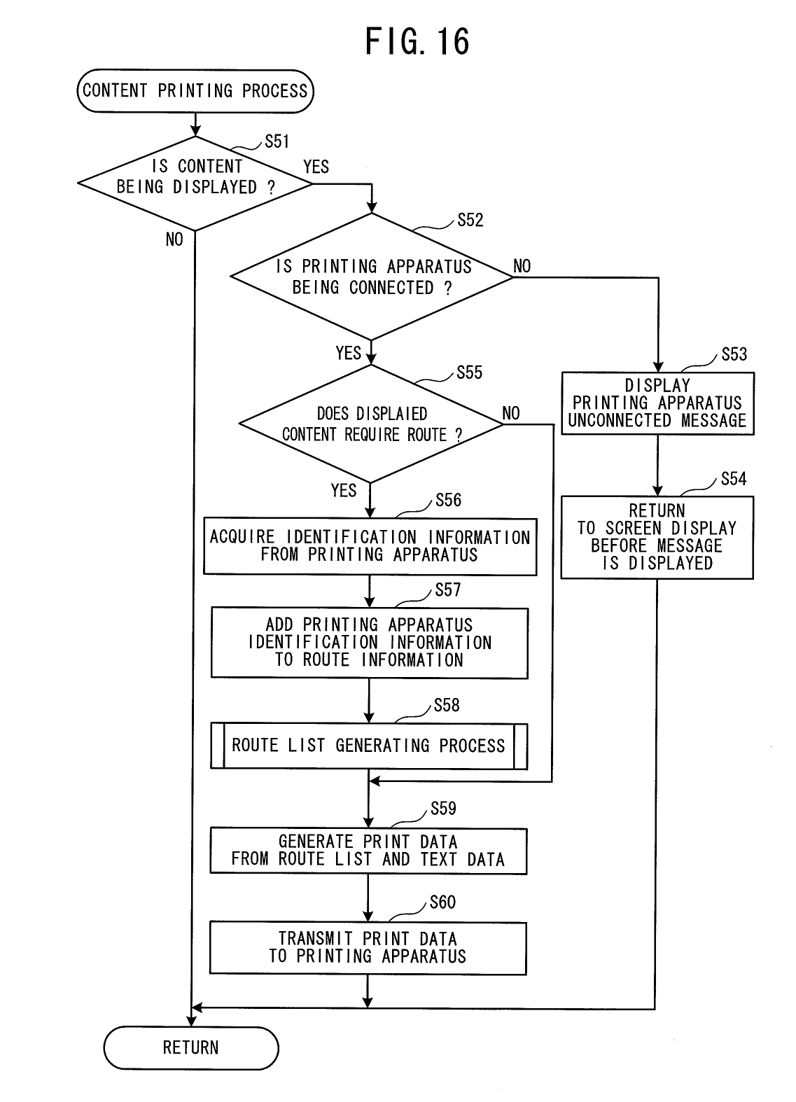

When the list display operation key is not operated (S27: NO), it is determined whether a content printing operation has been performed (S29). The content printing operation is performed when a print button displayed on the screen of the currently displayed content is selected by the input portion 14. When the content printing operation is performed (S29: YES), a content printing process is executed (S30). The content printing process will be described below with reference to FIGS. 16 to 18.

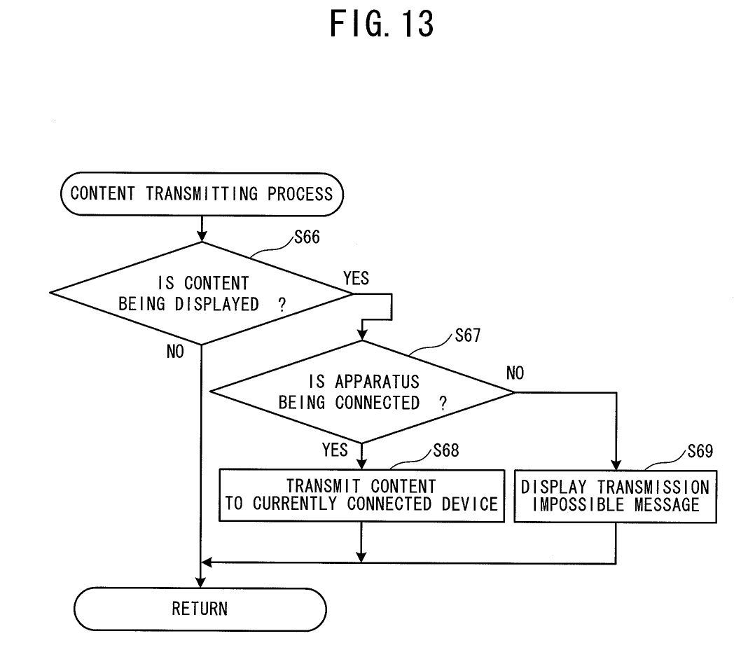

When the content printing process is not performed (S29: NO), it is determined whether the content transmitting operation has been performed on the basis of whether a transmission button was selected (S31). When the content transmitting operation is performed (S31: YES), a content transmitting process is executed (S32). In the content transmitting process, as shown in FIG. 13, when a content is being displayed (S66: YES), it is determined on the basis of a monitor result obtained by the external communication I/F 16 whether the mobile apparatus 1 is being connected to another device (S67). When another device is connected to the mobile apparatus 1 (S67: YES), the content displayed on the display portion 15 is transmitted to the currently connected device (S68). The process returns to the key input waiting process and then returns to the mobile apparatus main process. When no device is connected to the mobile apparatus 1 (S67: NO), a transmission impossible message “transmission is impossible” is displayed on the display portion 15 for a predetermined period of time (S69). The process returns to the key input waiting process and then returns to the mobile apparatus main process. When no content is displayed on the display portion 15 when the content transmitting operation is performed (S66: NO), a key operation becomes invalid. The process directly returns to the key input waiting process and then directly returns to the mobile apparatus main process.

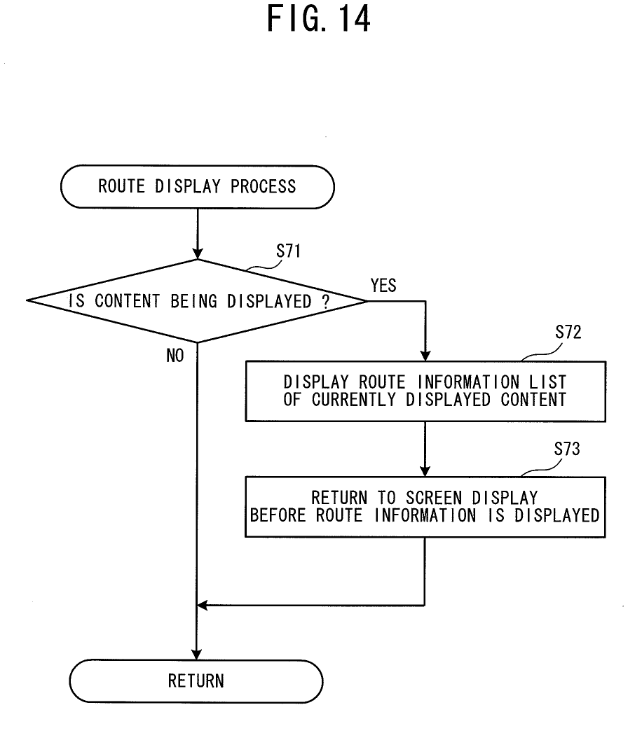

When the content transmitting operation is not performed (S31: NO), it is determined whether a route display operation has been performed on the basis of whether a route display button was selected (S33). When the route display operation is not performed (S33: NO), the process directly returns to the mobile apparatus main process. When the route display operation is performed (S33: YES), a route display process is executed (S34). In the route display process, as shown in FIG. 14, when a content is being displayed on the display portion 15 (S71: YES), route information in content data of the currently displayed content is read from the content data storage area 191 of the memory card 19, and a list of the route information is displayed on the display portion 15 (S72). After a predetermined period of time has elapsed, the display contents are returned to a screen display obtained before the route information is displayed (S73). The process returns to the key input waiting process and then returns to the mobile apparatus main process. When no content is being displayed (S71: NO), a key operation becomes invalid. The process directly returns to the key input waiting process and then directly returns to the mobile apparatus main process.

The process returns to the flow chart in FIG. 6, and the key input waiting process is finished (S4). Next, it is determined whether a content has been received from another device (S5). When a content is not received (S5: NO), the process directly returns to the determination in S3. When a content is received (S5: YES), content data is received and stored in the content data storage area 191 of the memory card 19 (S6), and a route addition process is executed (S7). In the route addition process, identification information of the mobile apparatus 1 itself is added to route information of received content data, and a process of creating the latest route information is performed.

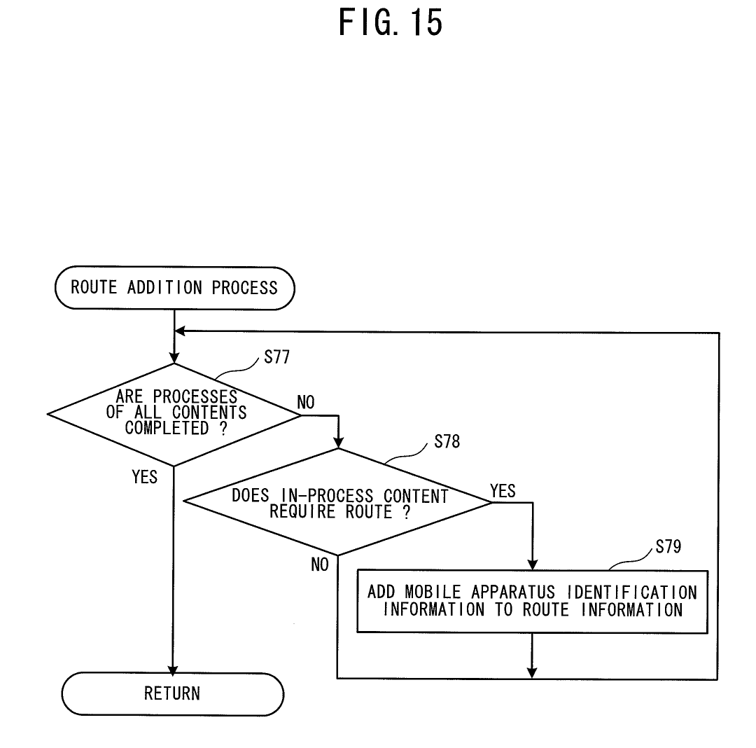

Details of the route addition process will now be described below with reference to FIG. 15. As shown in FIG. 15, in the route addition process, it is determined whether route addition process for all the content data received by the mobile apparatus 1 are completed (S77). When the route addition process is not completed (S77: NO), the route addition process is sequentially performed (S78 and S79). It is first determined whether a route of the in-process content data should be stored (S78). When the route required/unrequired information of the content data (see FIG. 3) does not indicate that the route of the content should be stored (S78: NO), the process directly returns to the determination in S77. When the route required/unrequired information indicates that the route should be stored (S78: YES), the identification information (device ID and user name) and the contact information to a user stored in the EEPROM 13 (see FIG. 4), the current time measured by the timer portion 17, and “copy” which indicates an attribute are added to the route information (S79). Then the process returns to the determination in S77. When the route addition process for the all content data received by the mobile apparatus 1 is completed (S77: YES), the process returns to the mobile apparatus main process. In the mobile apparatus main process (see FIG. 6), when the route addition process (S7) is finished, the process returns to the determination in S3.

With reference to FIGS. 16 to 18 a description will be given of a content printing process executed in the key input waiting process of the mobile apparatus main process. When the content printing operation is performed to execute the content printing process, as shown in FIG. 16, it is determined whether the content is being displayed on the display portion 15 (S51). When the content is not being displayed (S51: NO), the process directly returns to the key input waiting process and then returns to the main process. When the content is being displayed on the display portion 15 (S51: YES), it is determined on the basis of a monitor result obtained by the external communication I/F 16 whether the mobile apparatus 1 is connected to the printing apparatus 3 (S52). When the mobile apparatus 1 is not being connected to the printing apparatus 3 (S52: NO), a printing apparatus unconnected message “not connected to the printing apparatus” is displayed on the display portion 15 (S53). After a predetermined period of time has elapsed, the display contents are returned to the screen display obtained before the message is displayed (S54). The process returns to the key input waiting process and then returns to the mobile apparatus main process.

When the mobile apparatus 1 is being connected to the printing apparatus (S52: YES), it is determined whether a route of content to be printed should be stored (S55). When the route required/unrequired information of the content data (see FIG. 3) does not indicate that the route of the content should be stored (S55: NO), print data is generated from text data of the content (S59). The generated print data is transmitted to the printing apparatus 3 (S60). The process returns to the key input waiting process and then returns to the mobile apparatus main process. On the other hand, when the route required/unrequired information indicates that the route information of the content should be stored (S55: YES), a request to transmit identification information to the printing apparatus 3 is made to acquire the identification information of the printing apparatus 3 (S56). The identification information of the printing apparatus 3 is added to the route information of the content data (see FIG. 3) (S57). More specifically, a device ID and a user name (installation place) serving as the identification information acquired from the printing apparatus 3, a current time measured by the timer portion 17, and “print” which indicates an attribute are added to the route information. A route list generating process (S58) is then executed. In this route list generating process, a maximum number of pieces of printable identification information is extracted from a plurality of identification information stored in each stopover device as the route information according to priority conditions and generated as a route list.

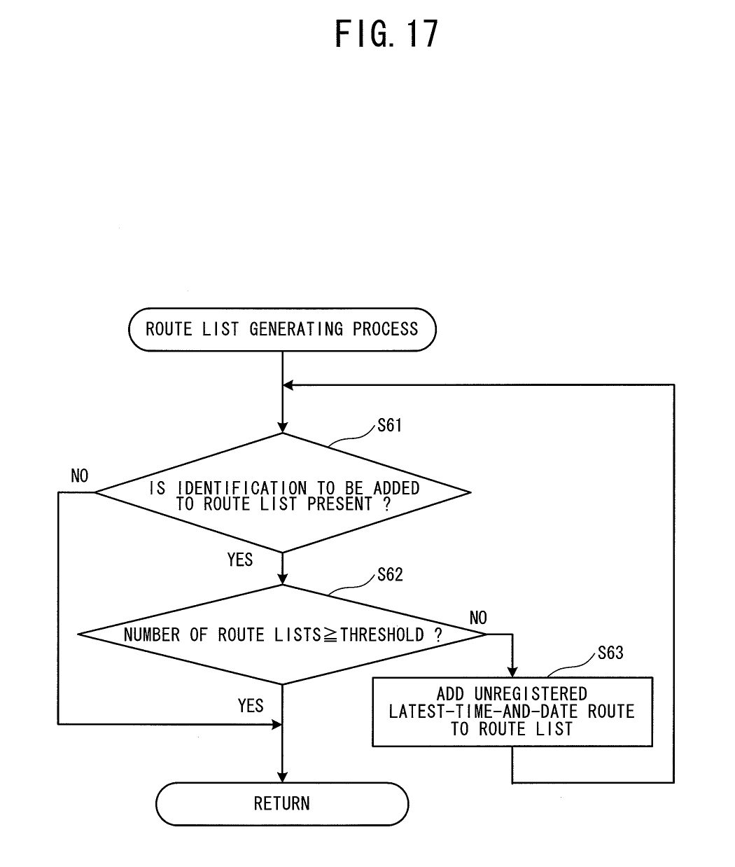

As shown in FIG. 17, when the route list generating process is started, it is determined whether the route information of the content data (see FIG. 3) includes identification information to be added to the route list (S61). When the route information includes the identification information to be added to the route list (S62: YES), it is determined whether the number of lists of the identification information added to the route list is equal to or larger than a threshold indicating a maximum number of printable lists (S62). When the number of lists is smaller than the threshold (S62: NO), the identification information having the latest time and date at which the content was acquired is added to the route list among pieces of identification information which are not registered in the route list yet (S63). The process then returns to the determination in S61. When the route information includes no identification information to be added to the route list (S61: NO), or when the number of lists of identification information added to the route list is equal to or larger than the threshold (S62: YES), the process returns to the content printing process.

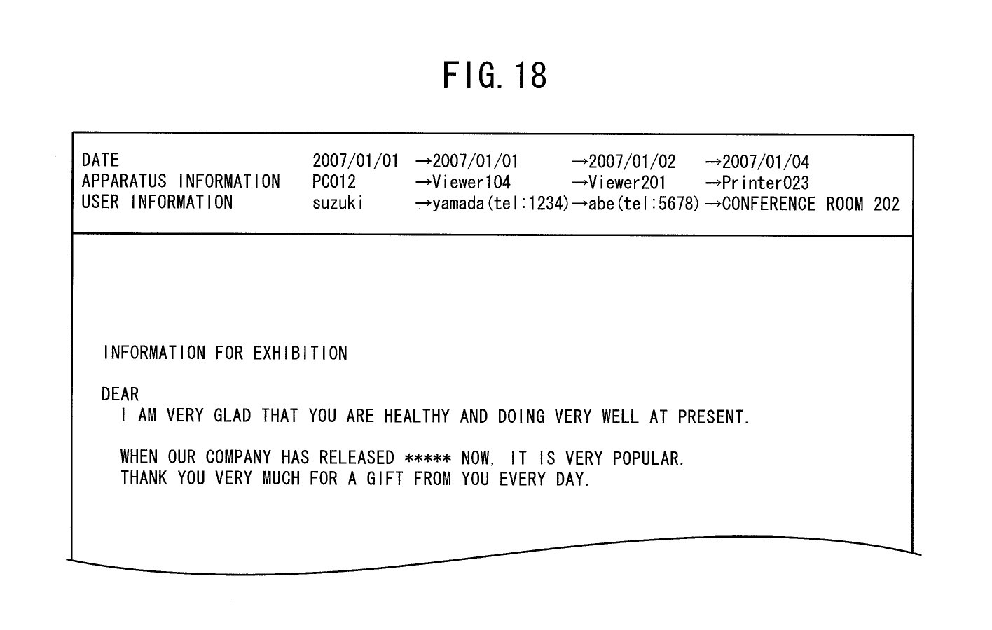

Then the process returns to FIG. 16. When the route list generating process (S58) is finished, print data is generated from the generated route list and the text data of the content (S59). The generated print data is transmitted to the printing apparatus 3 (S60). The process returns to the key input waiting process and then returns to the mobile apparatus main process. At this time, as shown in FIG. 18, the route information is printed by the printing apparatus 3 together with the substance of the content. Therefore, a source of leakage can be easily investigated by the route information that is printed together with the substance of the content.

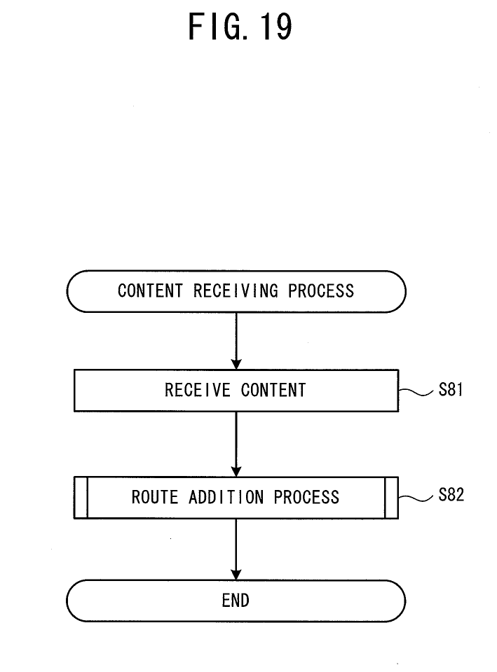

Processes in the computer apparatus 2 will now be described below with reference to FIGS. 19 to 21. A content receiving process and a content transmitting process (will be described later) are executed in the CPU 20 by the program stored in the ROM 21.

The content receiving process will first be described below. When the computer apparatus 2 receives a content from another device, the content receiving process shown in FIG. 19 is executed by interruption, and content data is received and stored into the content data storage area 233 of the HDD 23 (S81). In this case, when the memory card 19 is loaded on the computer apparatus 2, the received content data is also stored into the memory card 19. Then, a route addition process is performed (S82).

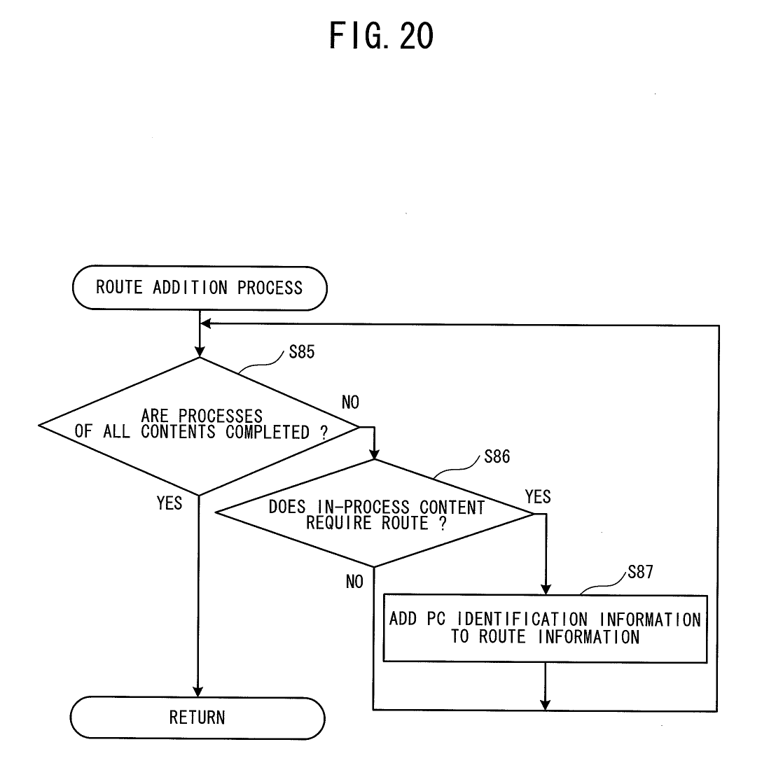

As shown in FIG. 20, when the route addition process is started, it is determined whether route addition process for all the content data received by the computer apparatus 2 have been completed (S85). When the route addition process are not completed yet (S85: NO), route addition process is sequentially performed, and it is determined whether in-process content data is data the route of which should be stored (S86). When the content data does not indicate that the route should be stored (S86: NO), the process directly returns to the determination in S85. When the content data indicates that the route should be stored (S86: YES), a device ID and a user name serving as identification information stored in the HDD 23 (see FIG. 5), a current time, and “copy” which indicates an attribute are added to the route information (S87). The process then returns to the determination in S85. When route addition process for the all content data received by the computer apparatus 2 are completed (S85: YES), the content receiving process is finished.

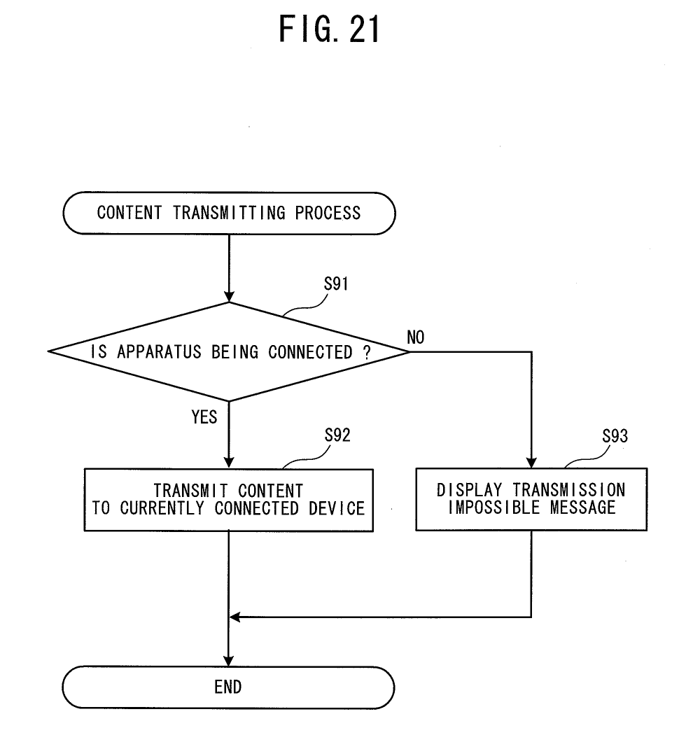

The content transmitting process will next be explained below. When a content is instructed to be transmitted to another device by operating the input portion 24 of the computer apparatus 2, the content transmitting process shown in FIG. 21 is executed by interruption. In the content transmitting process, it is determined whether another device which can transmit a content is being connected to the computer apparatus 2 on the basis of a monitor result obtained by the external communication I/F 26 (S91). When any device is connected to the computer apparatus 2 (S91: YES), a content instructed to be transmitted is transmitted to the currently connected device (S92), and the content transmitting process is finished. On the other hand, when no device is connected to the computer apparatus 2 (S91: NO), a transmission impossible message “transmission is impossible” is displayed on the display portion 25 for a predetermined period of time (S93), and the content transmitting process is finished.

As described above, according to the content viewing system including the mobile apparatus 1 according to the first embodiment, when a content is transferred and copied between a plurality of devices (the mobile apparatus 1 and the computer apparatus 2) to view the content, identification information which indicates a device ID and a user of a device to which the content is transferred and copied is added to the route information which indicates devices over which the content has stopped. Therefore, even though a content is leaked, a device or a user through which the leakage occurs can be tracked by means of the route information. Furthermore, leakage of the content can also be suppressed. The pieces of identification information are added to the route information in a stopover order, and the content is directly transferred and copied to another device without changing the stopover order. For this reason, the user can also accurately specify the stopover order of the content and can more easily manage a flow of information.

The identification information is added to the route information in each of the case in which a content is transferred or copied by replacing the memory cards 19 and the case in which a content is transferred or copied by transmitting data. Therefore, the user can recognize a route of the content while improving the convenience in transfer and copying of the content. When the content is to be printed, a predetermined number of pieces of identification information are printed together with the substance of the content in a reverse chronological order of addition to the route information. Therefore, the user can efficiently notify of new route information without vainly using a print space.

The first embodiment can be variably modified. First, in a route list generating process (see FIG. 17) of generating a list of the identification information which is printed together with the content, a predetermined number of pieces of identification information are added in the reverse chronological order of addition to the route information. However, this configuration can be changed. Various modifications of the route list generating process will be described below.

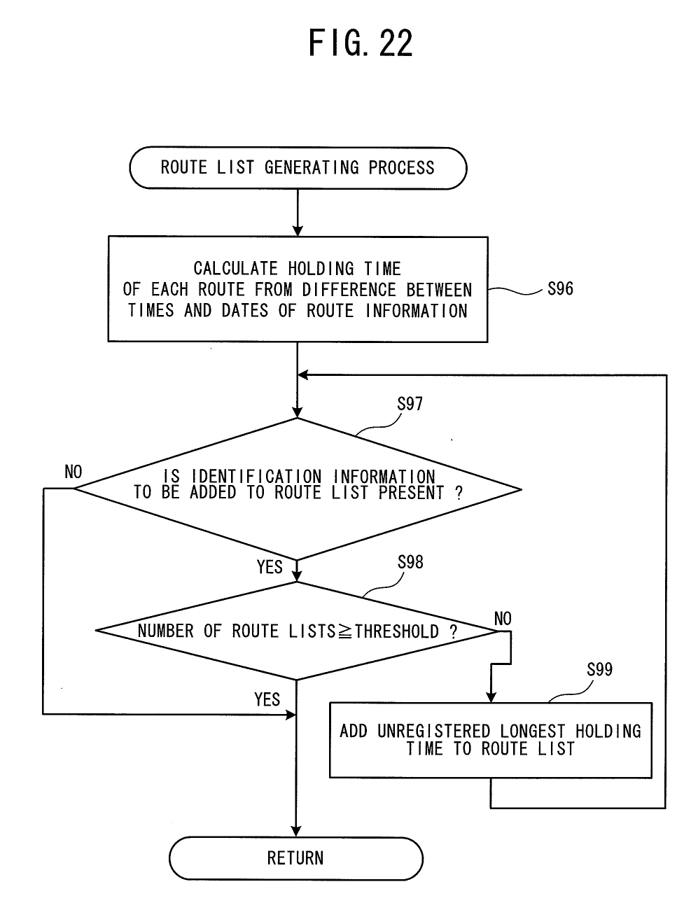

With reference to FIG. 22, a description will be given of a route list generating process performed when pieces of identification information are added to the list in a descending order of content holding times of routes. As shown in FIG. 22, when the predetermined number of pieces of identification information are to be printed in the descending order of content holding times, the holding time of each of the routes is calculated from a difference between times and dates of pieces of identification information (S96). In this case, a holding time of the latest route is defined as a difference between the time and date of the route information and a current time. Then it is determined whether the route information includes identification information to be added to the route list (S97). When the route information includes an identification information to be added (S97: YES), it is determined whether the number of lists of the identification information added to the route list is equal to or larger than a threshold which indicates the maximum number of printable lists (S98). When the number of lists is smaller than the threshold (S98: NO), the identification information of a route having the longest calculated holding time (S99) is added to the route list among pieces of identification information which are not registered in the route list, and the process returns to the determination in S97. When the route information includes no the identification information to be added to the route list (S97: NO), or when the number of lists of the identification information added to the route list is equal to or larger than the threshold (S98: YES), the process returns to the content printing process (see FIG. 16).

As described above, when the pieces of identification information are added to the list and printed in a descending order of holding times of routes, a device having a long content holding time or a user of the device can be easily recognized. The longer the content holding time is, the higher is the importance in route tracking when the content is leaked. For this reason, when a device having a long holding time or a user of the device is recognized, a high-risk user who leaked the content can efficiently be recognized without vainly using a print space.

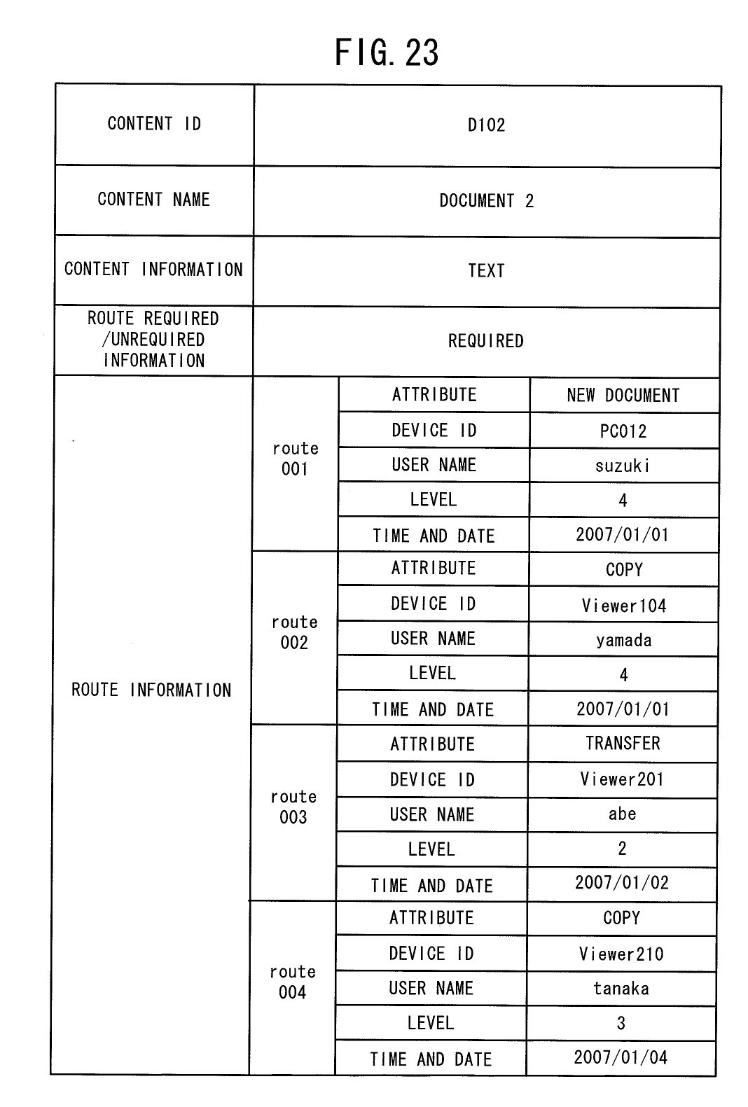

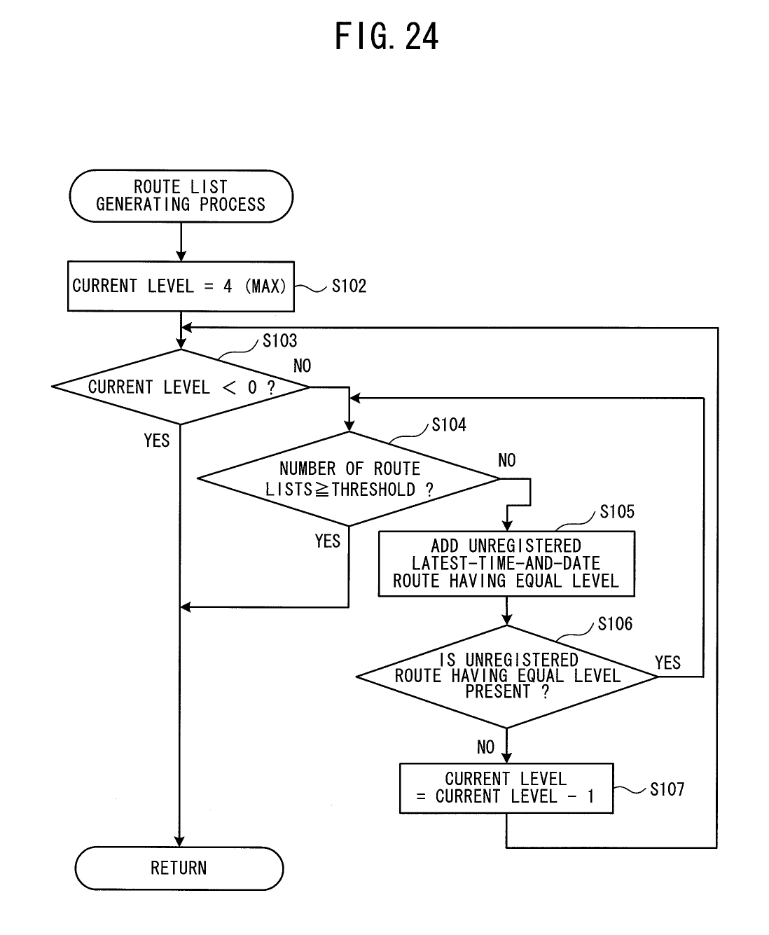

A route list generating process performed when pieces of identification information are added to the list in an order of priorities of users will be explained below with reference to FIGS. 23 and 24. When identification information of a user having a high priority is preferentially printed, a user level is set to any one of “4” to “0” in advance, and, in addition to information of a device ID and a user name, the user level is stored in the EEPROM or the HDD of each device. The level can also be changed. As shown in FIG. 23, the user level is also added to route information created each time a content stops over at each device.

As shown in FIG. 24, when the route list generating process is started, a current level which is a level set at present to determine the identification information to be added to the route list is set to “4” which is the maximum value (S102). It is then determined whether the current level is smaller than “0” (S103). When the current level is equal to or more than “0” (S103: NO), it is determined whether the number of lists of the route list is equal to or larger than a threshold (S104). When the number of lists is smaller than the threshold (S104: NO), the identification information about a stopover device having the latest time and date is added to the route list among pieces of identification information which have levels equal to the preset current level and are not registered in the route list yet (S105). Then it is determined whether identification information which has a level equal to the current level and is not registered yet in the route list is present (S106). When the identification information which has a level equal to the current level and is not registered yet in the route list is present (S106: YES), the process returns to the determination in S104. The process of adding the route information is repeated. When the number of lists is equal to or larger than the threshold (S104: YES), the process returns to the content printing process (see FIG. 16). When the unregistered route information which has a level equal to the current level is not present (S106: NO), “1” is subtracted from the current level (S107), and the process returns to the determination in S103. When the current level becomes smaller than “0” (S103: YES), the process returns to the content printing process.

As described above, priorities of users are set beforehand depending on security levels, ladders, or the like, a user who should be in charge of information leakage and a user who should perform security management can be easily recognized. Therefore, even though information leakage occurs, a source of leakage can be efficiently investigated.

The route list generating process can also be further changed. For example, after the process in S61 shown in FIG. 17, a subsequent process is performed after identification information of a stopover device which acquires a content at the oldest time and date has been added to the route list to make it possible to always recognize identification information related to a user or a device which creates a new content. For this reason, the creator of the content can be quickly specified. Therefore, it is convenient, for example, for making contact with a creator. In the process in S105 shown in FIG. 24, among unregistered routes which have a level equal to the current level, the identification information of a route having the latest time and date is added to the route list. However, as in the process shown in FIG. 22, a holding time may be calculated, and pieces of identification information may be added to the route list in a descending order of holding times of routes. In this manner, a user having a long content holding time can be efficiently recognized as a user who is highly likely to leak information. In the process shown in FIG. 24, a route list is created according to an order of priorities of users. However, the priorities of the users are not classified by levels but the priorities of the devices are classified by levels and set to devices, and pieces of identification information can be printed depending on the priorities. In this manner, a device can be easily recognized which is used by a user who should be in charge of information leakage.

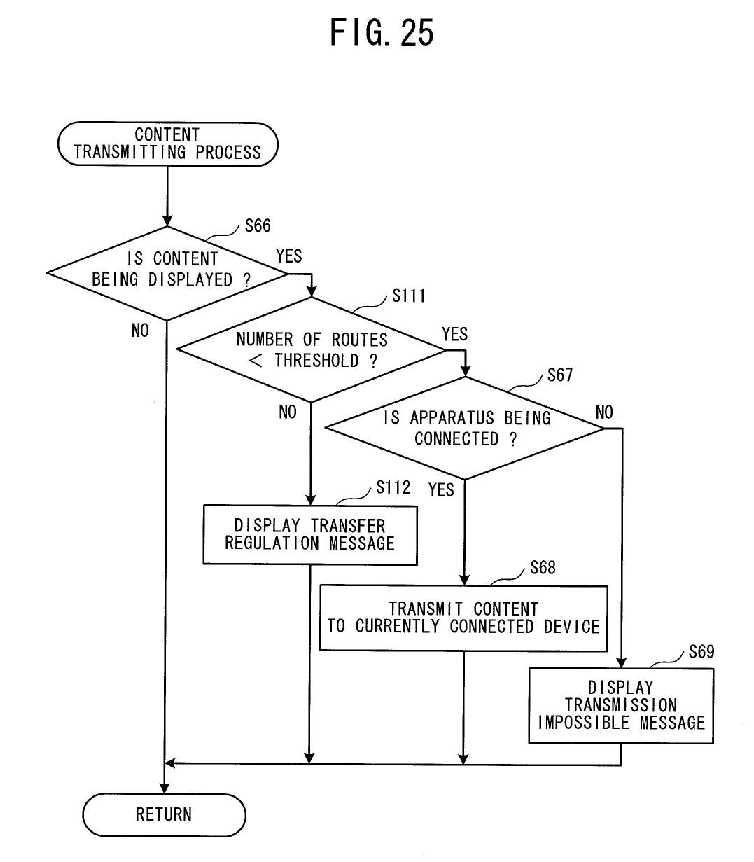

An operation of a mobile apparatus 1 according to the second embodiment of this disclosure will next be explained below with reference to FIG. 25. The mobile apparatus 1 according to the second embodiment is a modification of the first embodiment. The mobile apparatus 1 is characterized in that, when the number of times of transfer, copying, and printing of a content is equal to or larger than a predetermined number of times, the content is prohibited to be transmitted to another device. The mobile apparatus 1 according to the second embodiment is the same as that of the first embodiment except that a threshold which indicates the maximum number of pieces of identification information which can be stored is stored and except for a part of a content transmitting process (see S32 in FIG. 9) executed by a key input waiting process. Therefore, descriptions of other processes, an entire configuration, and an electrical configuration are not explained, and a description of the same process as the content transmitting process (see FIG. 13) in the first embodiment is simplified by adding the same step numbers to the process.

In the mobile apparatus 1 according to the second embodiment, a threshold indicating the maximum number of pieces of identification information which can be stored as route information (see FIG. 3) is stored in the threshold storage area 134 of the EEPROM 13 (see FIG. 4). The threshold can be changed. In the content transmitting process, as shown in FIG. 25, when an operation of transmitting a content which is being displayed on the display portion 15 of the mobile apparatus 1 to another device was performed (S66: YES), it is determined whether the number of the identification information stored as route information, i.e., the number of routes is smaller than the threshold (S111). When the number of routes is smaller than the threshold (S111: YES), a content transmitting process is performed on the basis of whether any device is connected (S67 to S69). On the other hand, when the number of routes is equal to or larger than the threshold (S111: NO), the identification information cannot be added to the route information. For this reason, a transfer regulation message “content cannot be transmitted to another device any more” is displayed on the display portion 15 (S112). The process returns to the key input waiting process and then returns to the mobile apparatus main process.

As described above, according to the mobile apparatus 1 of the second embodiment, when the number of pieces of identification information stored in each route as route information is equal to or larger than a predetermined number after a content is transferred, copied, and printed, the content can be prohibited from being transmitted to another device. Therefore, the number of times of transfer and copying of pieces of content information (content data) can be regulated in such a way as not to exceed a predetermined number. For this reason, the risk of information leakage due to repeating the transfer and copying can be prevented from being increased.

The second embodiment can also be modified. For example, a content is prohibited from being transmitted to another device when the number of routes has reached the maximum number. However, the content is not prohibited from being transmitted but is prohibited from being printed, or the content may be prohibited from being transferred by means of the memory card 19. Of three operations, i.e., the transfer, copying, and printing operations, two or more operations may be prohibited. In any case, the risk of increasing information leakage due to repeating transfer and copying can be prevented from being increased.

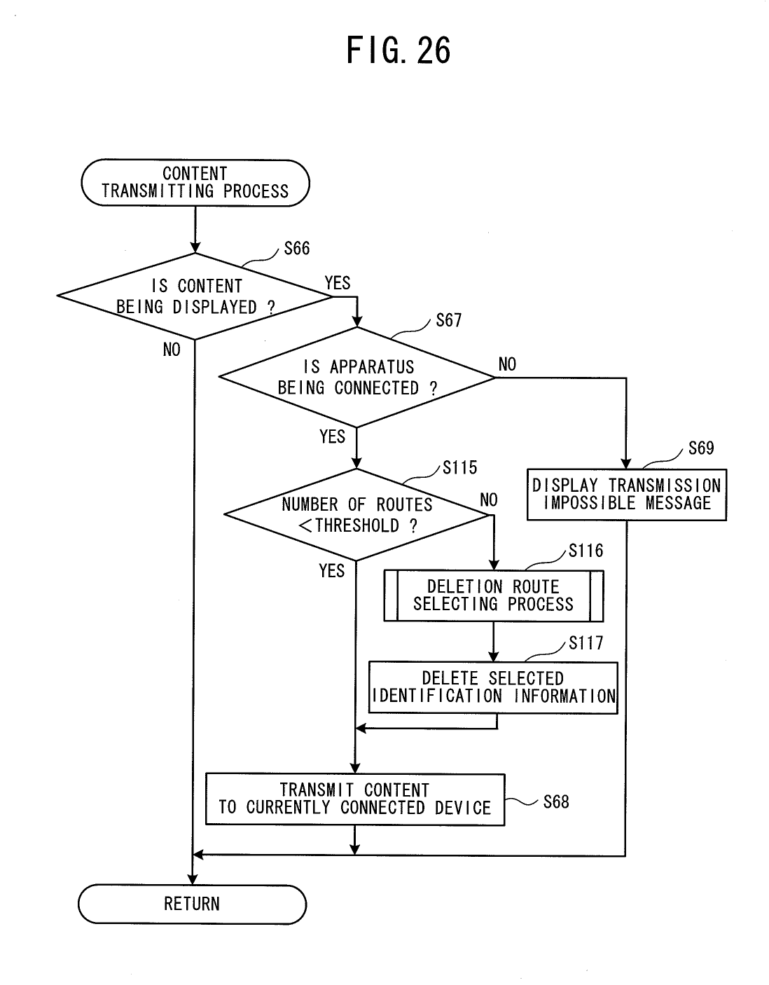

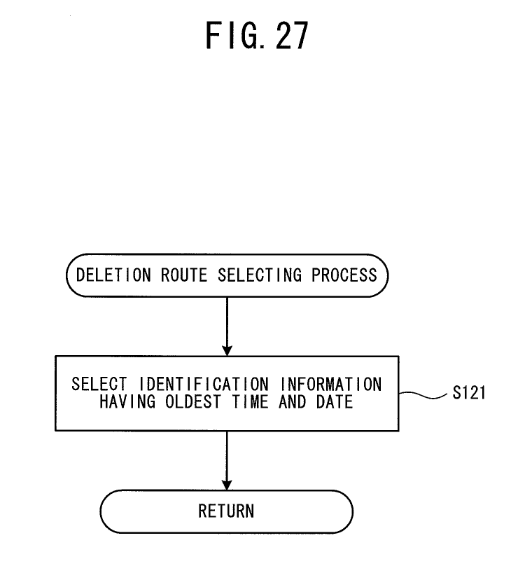

An operation of a mobile apparatus 1 according to the third embodiment of this disclosure will be explained below with reference to FIGS. 26 and 27. The mobile apparatus 1 according to the third embodiment is characterized in that when the number of pieces of identification information stored for each route as route information has reached a predetermined number or more, identification information having the lowest priority is deleted from the route information. The mobile apparatus 1 according to the third embodiment is the same as those of the first and the second embodiments except for a part of a content transmitting process (see S32 in FIG. 9) executed by a key input waiting process. Therefore, the same step numbers as those in the content transmitting process (see FIG. 13) in the first embodiment are assigned to the same process in the third embodiment in order to simplify the explanation of the content transmitting process, and other descriptions are not made.

In the mobile apparatus 1 according to the third embodiment, as in the second embodiment, a threshold indicating the maximum number of pieces of identification information which can be stored for each route as route information is stored in the threshold storage area 134 (see FIG. 4). This value can be set by a user. In a content transmitting process, as shown in FIG. 26, an operation of transmitting a currently displayed content to another device is performed (S66: YES). When another device is being connected to the mobile apparatus 1 (S67: YES), it is determined whether the number of pieces of identification information stored as the route information, i.e., the number of routes is smaller than a threshold (S115). When the number of routes is smaller than the threshold (S115: YES), a content is transmitted to the currently connected device (S68). The process returns to the key input process. On the other hand, when the number of routes is equal to or larger than the threshold (S115: NO), a deletion route selecting process is executed (S116). In the deletion route selecting process, as shown in FIG. 27, identification information of a route in which information of a time and date is the oldest is selected as identification information to be deleted (S121). The process returns to the content transmitting process. The selected identification information (device ID and user name) and information such as an attribute and contact information corresponding to the selected identification information are deleted from the route information (S117), and content data including the route information is transmitted to the currently connected device (S68). The process returns to the key input waiting process.

As described above, according to the mobile apparatus 1 of the third embodiment, when the number of pieces of identification information stored for each route as route information has reached a predetermined number or more, identification information of a route in which an acquiring time and date of a content is the oldest can be deleted from the route information. In this manner, pieces of identification information can be prevented from being infinitely added to the route information, and a flow of information can therefore be efficiently managed while preventing a process load on the device due to increase of data amount.

The third embodiment can be variably modified. For example, in the deletion route selecting process according to the third embodiment (see FIG. 27), identification information of a route in which an acquiring time and date of a content is the oldest is to be deleted as identification information having a low priority. However, the method for selecting the identification information to be deleted can be changed. Variable modifications of the deletion route selecting process will be described below.

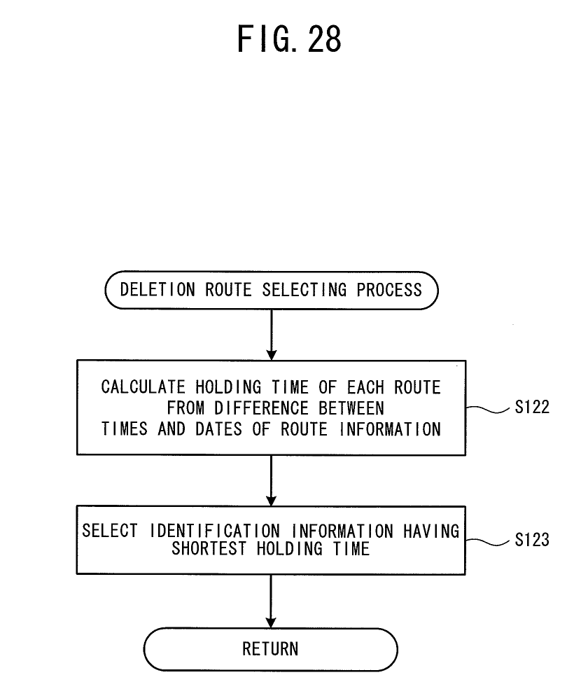

A deletion route selecting process performed when identification information of a route in which a content holding time is the shortest is to be deleted as identification information having a low priority will be explained with reference to FIG. 28. As shown in FIG. 22, when the identification information of the route in which the content holding time is the shortest is selected as identification information to be deleted, a holding time of each route is calculated from a difference between times and dates of pieces of identification information (S122). In this case, the holding time of the latest route is defined as a difference between the time and date of the route information and a current time. Then identification information of a route in which the calculated holding time is the shortest is selected as identification information to be deleted (S123). The process returns to the content transmitting process (see FIG. 26).

As described above, by deleting pieces of identification information in an ascending order of holding times, identification information having a long holding time can be left as identification information related to a user or a device each having a high risk of leaking information. For this reason, management of a flow of information can be efficiently executed. When an accurate holding time of each route is calculated even after deletion of the identification information, without using a difference between times and dates of pieces of route information as a holding time, the calculation can be realized by adding holding time information to route information each time identification information is newly added.

A deletion route selecting process performed when pieces of identification information are to be deleted in an ascending order of preset priorities of users will be described. In this case, the level of each of the user is set in advance to any one of “4” to “0”, and the set levels are stored in an EEPROM, an HDD, or the like of each device. As in the modification shown in FIG. 23, a level of a user is added to route information created each time a content stops over at each device in accordance with the identification information.

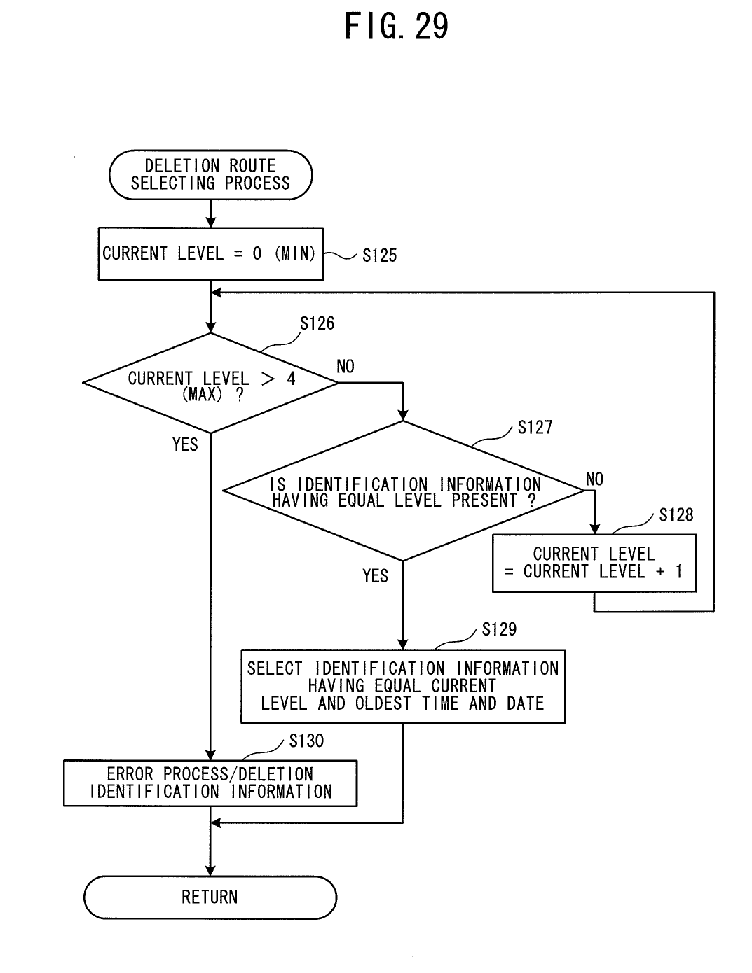

As shown in FIG. 29, when the deletion route selecting process is executed, a current level which is a level set at present is set to “0” which is a minimum value (S125). Then it is determined whether the current level is larger than “4” (S126). When the current level is equal to or smaller than “4” (S126: NO), it is determined whether identification information corresponding to a user having a level equal to the set current level is present (S127). When the identification information corresponding to the user having the level equal to the set current level is not present (S127: NO), “1” is added to the current level (S128), and the process returns to the determination in S126. When the identification information corresponding to the user having the level equal to the set current level is present (S127: YES), identification information of a user having the level equal to the current level and the oldest time and date is selected as identification information to be deleted (S129), and the process returns to the content transmitting process (SEE FIG. 26). When the current level is larger than “4” without selecting the identification information to be deleted (S126: YES), an error process is performed, and the route information is deleted (S130). The process returns to the content transmitting process.

As described above, priorities of users are set in advance according to security levels, ladders, or the like to delete pieces of identification information in an ascending order of the set priorities of the users. Therefore, identification information of a user who should be in charge of information leakage can be managed as route information, and a source of leakage can be efficiently investigated according to the priorities of the users. The deletion route selecting process can also be further changed. For example, in the process in S129, identification information of a route in which a content holding time is the shortest is selected as identification information to be deleted to make it possible to leave identification information of a route having a long holding time as identification information related to a user and a device having a high risk of leaking information. The priorities of the users are not classified by levels but the priorities of the devices are classified by levels and set to each device, and identification information to be deleted is selected according to the priorities, so that a device used by a user who should be in charge of information leakage can easily be recognized.

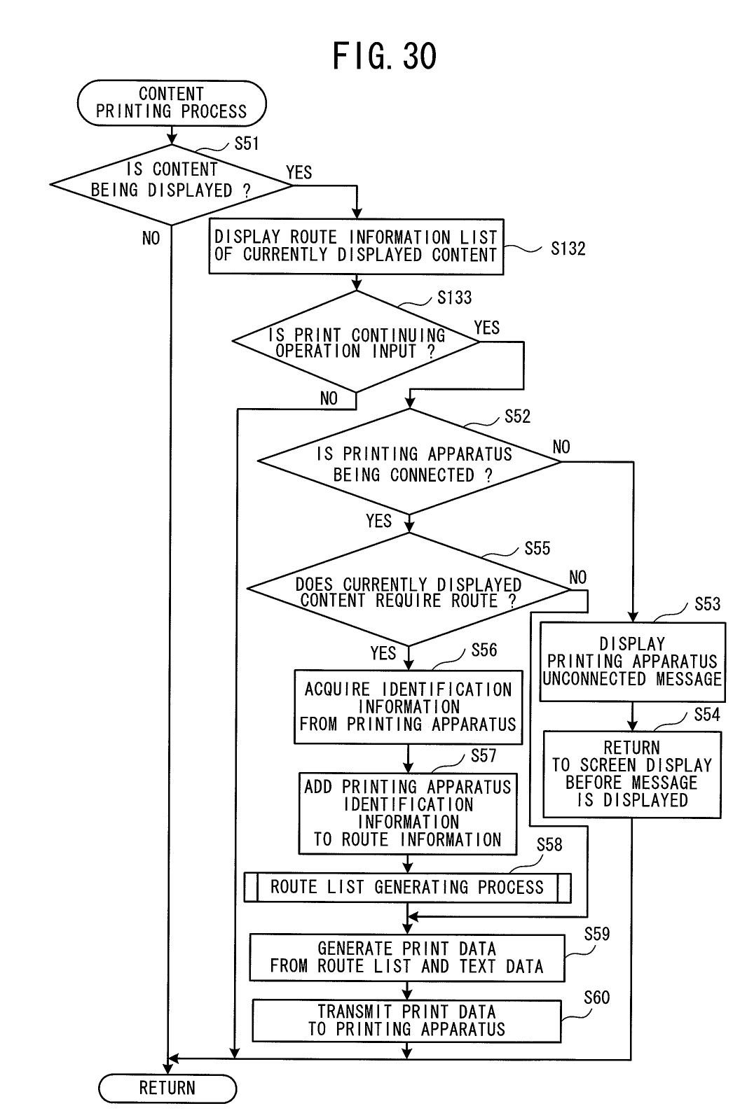

An operation of a mobile apparatus 1 according to the fourth embodiment will be explained below with reference to FIG. 30. The mobile apparatus 1 according to the fourth embodiment is a modification of the first embodiment, and is characterized in that print data is not transmitted to the printing apparatus 3 if a user does not permit to print route information together with contents of a content. The mobile apparatus 1 according to the fourth embodiment is the same as that of the first embodiment except for a part of the content printing process (see S30 in FIG. 9) executed by a key input waiting process. Therefore, other processes and configurations are not described, and the same step numbers as in the content printing process (see FIG. 16) in the first embodiment are assigned to the same process in the fourth embodiment to simplify the description of the content printing process.

As shown in FIG. 30, in the content printing process in the fourth embodiment, when an operation of transmitting a currently displayed content to another device is performed (S51: YES), route information of the currently displayed content is displayed on the display portion 15 of the mobile apparatus 1 (S132). Then it is determined whether a print continuing process is performed (S133). When a print continuing button displayed on the display portion 15 is selected (S133: YES), the process shifts to a process related to printing (S52 to S60). On the other hand, when a print stop button is selected (S133: NO), the process ends a content printing process and returns to a key input waiting process.

As described above, according to the mobile apparatus 1 of the fourth embodiment, when a user causes the printing apparatus 3 to print a content, the user must permit to print the route information displayed on the display portion 15 together with substance of the content. Therefore, awareness of a user for information leakage can be boosted. Since a user who cannot bear responsible for information leakage can cancel printing, information leakage can more effectively suppressed.

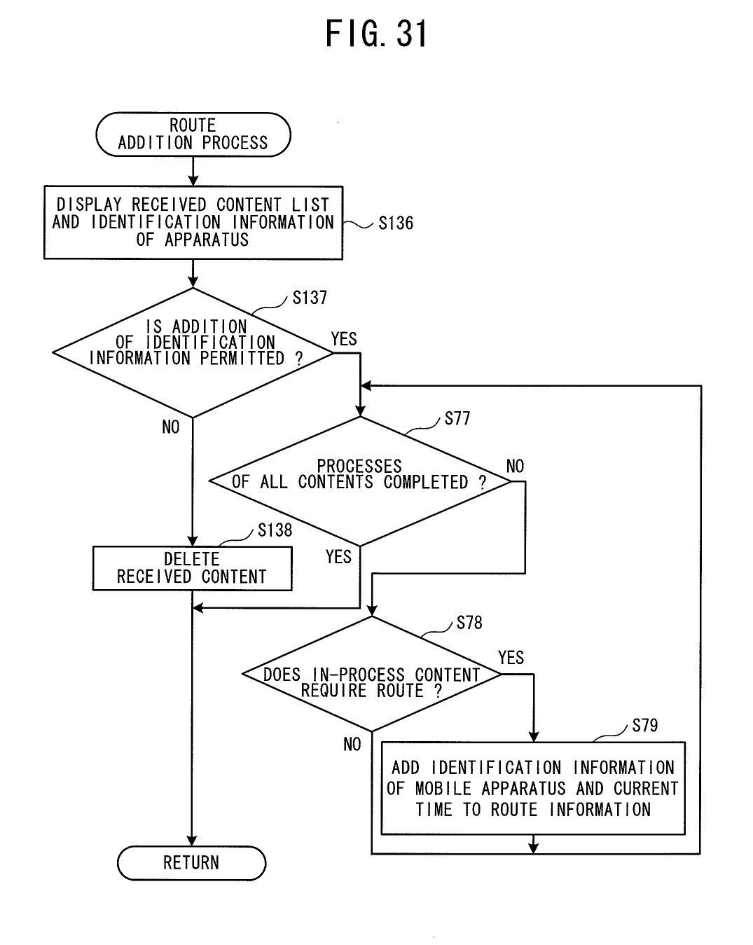

An operation of a mobile apparatus 1 according to a fifth embodiment of this disclosure will be explained below with reference to FIG. 31. The mobile apparatus 1 according to the fifth embodiment is a modification of the first embodiment. The mobile apparatus 1 of this disclosure is characterized in that a content cannot be received from another device until a user permit to add a device ID of an in-use device and a user name of the mobile apparatus 1 itself to route information. The same step numbers as in the route addition process (see FIG. 15) in the first embodiment are assigned to the same process in the fifth embodiment to simplify the description of the route addition process. Since all processes and configurations except for the route addition process are the same as those of the first embodiment, the processes and the configurations are not explained.

As shown in FIG. 31, the route addition process in the fifth embodiment is started, when a list of received contents, identification information (device ID and user name) of the mobile apparatus 1 itself stored in the EEPROM 13 (see FIG. 4), and contact information to a user are displayed on the display portion 15 of the mobile apparatus 1 (S136). It is determined whether the user permits to add the displayed information to route information of a received content (S137). When an “permit” button displayed on the display portion 15 is selected (S137: YES), a process of receiving a content and adding identification information or the like to the route information is performed (S77 to S79). On the other hand, when a “not permit” button is selected (S137: NO), content data received by the mobile apparatus 1 is deleted from the memory card 19 (S138). The process returns to the mobile apparatus main process (see FIG. 6).

As described above, according to the mobile apparatus 1 of the fifth embodiment, when a content is received from another device, a user must permit to add a device ID of an in-use device and a user name of the mobile apparatus 1 itself to route information. For this reason, awareness of a user for information leakage can be boosted. Information displayed in S136 can be changed, for example, all pieces of route information in content data may be displayed, or only a specific piece of information among pieces of information stored in the EEPROM 13 may be displayed.

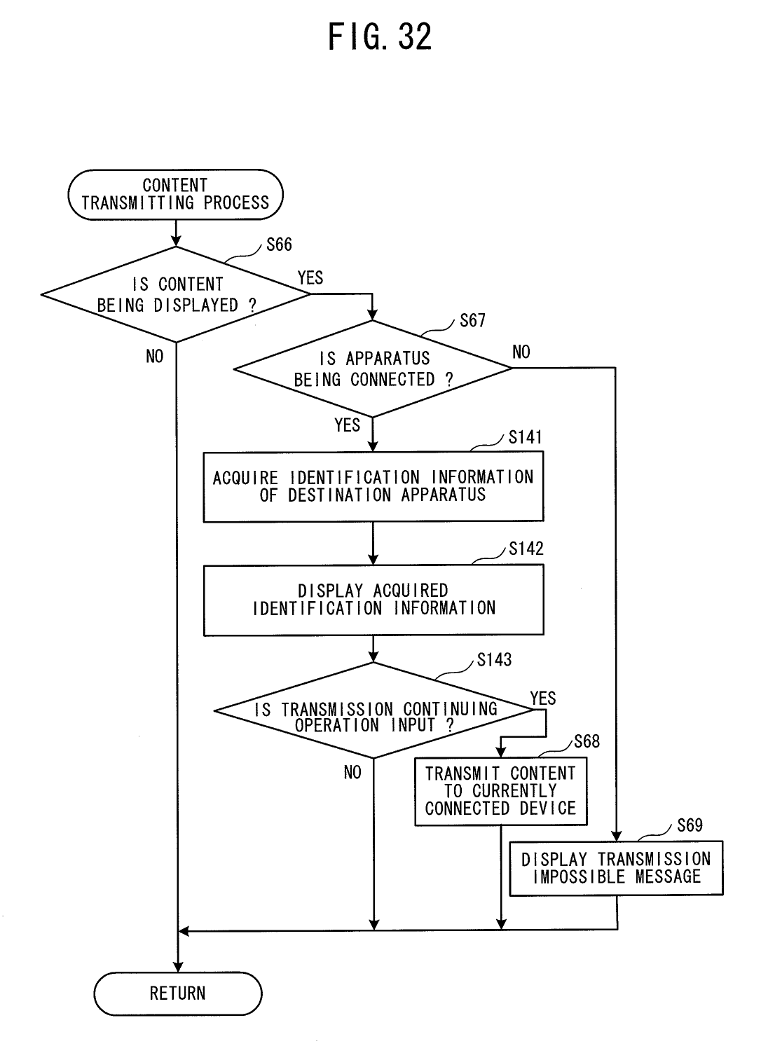

An operation of a mobile apparatus 1 in a sixth embodiment of this disclosure will be explained below with reference to FIG. 32. The mobile apparatus 1 in the sixth embodiment is a modification of the first embodiment. The mobile apparatus 1 is characterized in that a content cannot be transmitted to another device until a user permits to add identification information of a destination device to route information. The same step numbers as in the route addition process (see FIG. 13) in the first embodiment are assigned to the same process in the sixth embodiment to simplify the description of the content transmitting process. Since all processes and configurations except for the content transmitting process are the same as those of the first embodiment, the processes and the configurations are not described.

As shown in FIG. 32, in the content transmitting process in the sixth embodiment, an operation of transmitting a currently displayed content to anther device is performed (S66: YES). When another device is being connected (S67: YES), a transmission request of identification information is transmitted to a connected destination device, and identification information of the destination device is acquired (S141). The acquired identification information is displayed on the display portion 15 of the mobile apparatus 1 (S142), and it is determined whether a transmission continuing operation has been performed (S143). When a transmission continuing button displayed on the display portion 15 is selected (S143: YES), content data is transmitted to a currently connected device (S68). The process returns to the key input waiting process (see FIG. 9). On the other hand, when a print stop button is selected (S143: NO), the process directly returns to the key input waiting process without transmitting the content data.

As described above, according to the mobile apparatus 1 of the sixth embodiment, when a user transmits a content to another device, the user must permit to add identification information of a destination device to route information. Therefore, awareness of a user for information leakage can be boosted, and leakage can be prevented.

This disclosure is not limited to the first to sixth embodiments, and can be variably modified. First the mobile apparatus 1 and the computer apparatus 2 according to the above-mentioned embodiments may be any devices as long as they can view a content. This disclosure can also be applied to other devices such as a mobile phone. The computer apparatus 2 may also execute all the processes which can be executed by the mobile apparatus according to the above embodiments. In addition to identification information such as a device ID, content data may be stored in the EEPROM 13 of the mobile apparatus. Furthermore, in the above-mentioned embodiments, a device ID to identify a device and a user name to identify a user of the device are stored together as route information. However, when at least one of the device ID and the user name is stored, a route of a content can be tracked.

A user name stored as route information (see FIG. 3) is registered beforehand in the EEPROM 13 (see FIG. 4) by a user. However, a password of the user may be input when the mobile apparatus is started, and a log-in user name identified by the password may be added to the route information. As shown in FIG. 18, in the above-mentioned embodiments, the route information is printed on an upper part of a sheet of paper. However, a printing position may be changed. Printing may be performed by a woven pattern which become visible as a character when the sheet of paper is duplicated on a copy machine, or a woven pattern which can be recognized by carefully watching the sheet of paper, or the like.

In the above-mentioned embodiments, data is copied when content data is transmitted or received. However, the transmitted content data may be set to be deleted to make it possible to prohibit a content from being copied by a method other than printing. In this manner, the security of the content can also be further improved. In the above-mentioned embodiments, transfer of content data with the memory card 19 is executed while the power supply of the mobile apparatus is set in “OFF”. However, an exchange of the memory cards 19 may be detected when the power supply is set in “ON” to make it possible to transfer the content. In this case, the route check process shown in FIG. 7 may be executed by interruption. The above six embodiments and the modifications can be arbitrarily combined to each other, as a matter of course.

As described above, according to the content viewing apparatus in this disclosure, when content information which is electronic data of a content itself is acquired, route information composed of identification information to identify at least one of a stopover device over which the content has stopped and a user of the stopover device is acquired together with the content information. Route information obtained by adding identification information about a device of the content viewing apparatus itself to the acquired route information as a stopover device is created and stored in association with the content information. Therefore, even though the content leaks while being transferred or copied between devices, routes through which the content finally leaks can be tracked by the route information. Therefore, a source of leakage when the content information leaks can be easily investigated, and information leakage of the content can be suppressed.

The content viewing apparatus in this disclosure can output route information and content information to another device by information output device, and the output information is acquired by a destination device via a information acquiring device. More specifically, by using information output device, a content can be transferred and copied between devices. For this reason, the convenience of the content viewing apparatus can be improved. The route information is output together with the content information, and new route information is created in a destination content viewing apparatus. For this reason, even though information leaks while the content information is transmitted or received, routes up to leakage can be tracked.

Furthermore, in the content viewing apparatus according to this disclosure, a storing device is removed and loaded on another device to acquire content information and route information stored in the storing device by the information acquiring device. More specifically, since the storing device is moved to make it possible to transfer and copy a content between devices, the convenience of the content viewing apparatus can be improved. Further, since the identification information of the content viewing apparatus on which the storing device is loaded is added to the route information, routes up to leakage can be tracked.

Furthermore, in the content viewing apparatus according to this disclosure, identification information of the content viewing apparatus itself is added to the end of a stopover order of the route information, and the route information is directly transferred and copied to another device without changing the stopover order. Therefore, the user can accurately specify the stopover order of the content, and a management of a flow of information becomes easier.

Furthermore, when the content viewing apparatus in this disclosure accepts an instruction of printing a content, the content viewing apparatus can cause a printing apparatus to print, together with content information which accepts instruction of printing, route information corresponding to the content information. Therefore, a user can more easily manage a flow of information by the printed route information.

Furthermore, the content viewing apparatus in this disclosure can cause the printing apparatus to print identification information of a predetermined number of stopover devices as route information even though a content has stopped over at a large number of devices. Therefore, even though a space in which identification information is printed is small, the content viewing apparatus can notify a user of appropriate route information. Routes can be prevented from being cumbersomely recognized by printing a large number of pieces of route information.

The content viewing apparatus in this disclosure can notify a user of identification information of a predetermined number in a reverse chronological order of addition to the route information each time printing is performed. Therefore, the user can efficiently recognize the routes of the content.

The content viewing apparatus in this disclosure can notify a user of identification information of a predetermined number of stopover devices in a descending order of holding times of a content each time printing is performed. Therefore, the user can efficiently track routes of the content.

Furthermore, the content viewing apparatus in this disclosure can store priorities of users depending on, for example, security levels, ladders, or the like in a user priority storing device, and can cause a printing apparatus preferentially to print pieces of identification information related to the users having high priorities. Therefore, the users can efficiently recognize route information according to the priorities of the users.

Furthermore, the content viewing apparatus in this disclosure can store priority of each device in a device priority storing device, and cause a printing apparatus to preferentially print pieces of identification information of devices having high priorities. Therefore, a user can efficiently recognize the pieces of route information according to the priorities of the devices.

Furthermore, the content viewing apparatus in this disclosure can display route information printed together with a content on a display device and cause a printing apparatus to execute printing when a user permits to print the route information. In this manner, awareness of a user for information leakage can be boosted. Since a user who cannot bear responsibility for information leakage can cancel printing, leakage can be effectively suppressed.

Furthermore, the content viewing apparatus in this disclosure can prohibit content information from being transferred and copied to another device when the number of pieces of identification information stored in the storing device as route information is equal to or larger than a predetermined number. Therefore, when a user causes a plurality of users to circulate a content, the user can freely regulate the number of times of transfer and copying. For this reason, the possibility of information leakage due to unlimitedly transfer and copying of the content can be reduced.

Furthermore, when the number of pieces of identification information stored as route information has reached the maximum number for storage, the content viewing apparatus in this disclosure can delete pieces of identification information having low priorities from the route information. Therefore, the pieces of identification information can be prevented from being unlimitedly added to the route information. For this reason, a user can efficiently manage a flow of information while preventing a process load on a device due to increase of data amount.

Furthermore, when the content viewing apparatus in this disclosure acquires content information from another device, user permission for newly adding identification information of the content viewing apparatus acquiring the content information to route information can be used as a condition for acquisition of the information. Therefore, awareness of a user for information leakage can be boosted.

Furthermore, when the content viewing apparatus in this disclosure outputs content information to another content viewing apparatus, user permission for newly adding identification information of the destination content viewing apparatus to route information can be used as a condition for the information output. Therefore, awareness of a user for information leakage can be boosted.

Furthermore, a content viewing program recorded on a computer-readable recording medium in this disclosure is executed by a computer to make it possible to obtain the same effect as that of the content viewing apparatus according to this disclosure.

While the invention has been described in connection with various exemplary structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A content viewing apparatus capable of performing the transfer and copying of a content, comprising:
a display device that displays the content composed of an image or a document;
an information acquiring device that acquires route information composed of
identification information including at least one of device identification information which identifies a stopover device over which the content has stopped and
user identification information which identifies a user of the stopover device, and
content information which relates to the substance itself of the content;
a route information creating device that creates route information obtained by adding identification information of the content viewing apparatus itself as a stopover device to the route information acquired by the information acquiring device; and
a route information storing device that associates the route information created by the route information creating device with the content information and store the associated information into a storing device.

2. The content viewing apparatus according to claim 1, further comprising:
an information output device that outputs the route information stored in the storing device and the content information corresponding to the route information to another content viewing apparatus.

3. The content viewing apparatus according to claim 1, wherein the storing device is detachable.

4. The content viewing apparatus according to claim 1, wherein the pieces of identification information are shown in a stopover order in the route information, and
the route information creating device creates route information obtained by adding identification information of the content viewing apparatus itself to an end of the stopover order of the pieces of route information acquired by the information acquiring device.

5. The content viewing apparatus according to claim 1, further comprising:
a print instruction accepting device that accepts an instruction of printing of the content; and
a print instruction transmitting device that transmits an instruction to print the route information corresponding to the content information to a printing apparatus together with the content information which is instructed to be printed by the printing instruction accepted by the print instruction accepting device.

6. The content viewing apparatus according to claim 5, wherein the print instruction transmitting device transmits an instruction to print only a predetermined number of pieces of the identification information among a of pieces of the identification information stored in the route information storing device as the route information.

7. The content viewing apparatus according to claim 6, wherein the print instruction transmitting device transmits to the printing apparatus a predetermined number of pieces of the identification information in reverse chronological order of addition to the route information.

8. The content viewing apparatus according to claim 6, further comprising:
a holding time calculating device that calculates a time for which the stopover device holds the content information,
wherein the print instruction transmitting device transmits the pieces of identification information of the predetermined number of stopover devices in descending order of the holding times calculated by the holding time calculating device to the printing apparatus.

9. The content viewing apparatus according to claim 6, further comprising:
a user priority storing device that stores, for each user who uses the stopover device, an order of priorities in which the pieces of identification information are printed,
wherein the print instruction transmitting device preferentially transmits to the printing apparatus the identification information of the stopover device used by a user having a high priority stored in the user priority storing device.

10. The content viewing apparatus according to claim 6, further comprising:
a device priority storing device that stores, for each stopover device, an order of priorities in which the pieces of identification information are printed,
wherein the print instruction transmitting device preferentially transmits to the printing apparatus the identification information of the stopover device having a high priority stored in the device priority storing device.

11. The content viewing apparatus according to claim 5, further comprising:
a print route information display control device that displays the route information which is printed by the printing device together with the content on the display device; and
a print permission/rejection accepting device that accepts an instruction as to whether to permit printing of the content and the route information displayed on the display device by the print route information display control device,
wherein the print instruction transmitting device transmits a printing instruction to the printing apparatus when the print permission/rejection accepting device accepts permission of printing.

12. The content viewing apparatus according to claim 1, further comprising:
an identification information number determining device that determines whether the number of pieces of identification information stored as the route information in the storing device is equal to or larger than a predetermined number; and
a prohibiting device that prohibits the content information from being transferred and copied to another device when the identification information number determining device determines that the number of pieces of identification information is equal to or larger than the predetermined number.

13. The content viewing apparatus according to claim 1, further comprising:
a storing possible/impossible determining device that determines whether the number of pieces of identification information stored as the route information in the storing device has reached the maximum number of pieces of identification information which can be stored; and
an identification information deleting device that deletes the identification information having a low priority from the route information when the storing possible/impossible determining device determines that the number of pieces of identification information has reached the maximum number.

14. The content viewing apparatus according to claim 1, further comprising:
a route information addition permission/rejection accepting device that accepts an instruction as to whether to permit addition of the identification information to the route information when the content information and the route information are acquired by the information acquiring device,
wherein the information acquiring device acquires the content information and the route information only when the route information addition permission/rejection accepting device accepts the permission of the addition of the identification information to the route information.

15. The content viewing apparatus according to claim 1, further comprising:
an information output device that outputs route information stored in the storing device and content information corresponding to the route information to another content viewing apparatus; and
a destination information addition permission/rejection accepting device that, when route information and content information are output by the information output device, accepts an instruction as to whether to permit addition of the identification information on the destination content viewing apparatus to the route information,
wherein the information output device outputs the route information and the content information only when the destination information addition permission/rejection accepting device accepts the permission of the addition of the identification information to the route information.

16. A computer-readable recording medium storing a content viewing program of a content viewing apparatus capable of performing the transfer and copying of a content composed of an image or a document is recorded, wherein
the program comprises:
an information acquiring step of acquiring route information composed of identification information including at least one of device identification information which identifies a stopover device over which the content has stopped and user identification information which identifies a user of the stopover device, and content information which relates to the substance itself of the content;
a route information creating step of creating route information obtained by adding identification information of the content viewing apparatus itself as the stopover device to the route information acquired in the information acquiring step; and
a route information storing step of storing the route information created in the route information creating step in association with the content information.
